(19) United States
(12) Patent Application Publication
(10) Pub. No.: US 2024/0243924 A1
(43) Pub. Date: Jul. 18, 2024

(54) ATTESTATION MICROSERVICES AND SERVICE MESH FOR DISTRIBUTED WORKLOADS

(71) Applicants: Ned M. Smith, Beaverton, OR (US); Kshitij Arun Doshi, Tempe, AZ (US); Sunil Cheruvu, Tempe, AZ (US); Anahit Tarkhanyan, Cupertino, CA (US)

(72) Inventors: Ned M. Smith, Beaverton, OR (US); Kshitij Arun Doshi, Tempe, AZ (US); Sunil Cheruvu, Tempe, AZ (US); Anahit Tarkhanyan, Cupertino, CA (US)

(21) Appl. No.: 18/622,200

(22) Filed: Mar. 29, 2024

Related U.S. Application Data
(60) Provisional application No. 63/456,310, filed on Mar. 31, 2023.

(51) Int. Cl. H04L 9/32

(52) U.S. Cl. CPC H04L 9/3247

(57) ABSTRACT

Various systems and methods are described for implementing attestation microservices and an attestation microservice mesh for cloud-to-edge (C2E) and cloud-native deployments are disclosed. An example method performed by a computing node for coordinating attestation with a distributed workload includes: generating, with an attestation service, first attestation information to provide attestation of a resource at the computing node; generating, with the attestation service, second attestation information to provide attestation of a microservice at the computing node, with the microservice to use the resource at the computing node; generating, with the attestation service, third attestation information to provide attestation of a distributed workload, with the distributed workload to execute the microservice at the computing node; and outputting an attestation result for the distributed workload, based on the first attestation information, the second attestation information, and the third attestation information.

### PRIORITY CLAIM

This application claims the benefit of priority to U.S. Provisional Patent Application No. 63/456,310, filed Mar. 31, 2023, and titled “CLOUD TO EDGE SECURITY”, which is incorporated herein by reference in its entirety.

### BACKGROUND

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with compute security or data privacy requirements. Edge computing may, in some scenarios, provide a cloud-like distributed service that offers orchestration and management for applications among many types of storage and compute resources.

Some implementations of edge computing have been referred to as the “edge cloud” or the “fog,” as powerful computing resources previously available only in large remote data centers are moved closer to endpoints and made available for use by consumers at the “edge” of the network. The use of edge computing, and the many flavors of distributed or centralized cloud computing, have led to a variety of technical issues involving security, reliability, and resource usage.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a trusted cloud-to-edge services framework, according to an example;

FIG. 2 is a block diagram illustrating the components of a Container-as-a-Service layer, according to an example;

FIG. 3 is a block diagram illustrating the components of a Platform-as-a-Service layer, according to an example;

FIG. 4 is a block diagram illustrating the components of an Infrastructure-as-a-Service layer, according to an example;

FIG. 5 is a block diagram illustrating various Infrastructure-as-a-Service layers and trust management capabilities, according to an example;

FIG. 6 is a block diagram illustrating a workflow of a workload, according to an example;

FIG. 7 is a block diagram illustrating attestation load distribution, according to an example;

FIG. 8 is a block diagram illustrating an elastic workload mesh architecture, according to an example;

FIG. 9 is a block diagram illustrating attestation of a distributed workload using an attestation mesh, according to an example;

FIG. 10 is a block diagram illustrating an attestation mesh token structure, according to an example;

FIG. 11 is a block diagram illustrating a fully articulate attestation mesh token, according to an example;

FIG. 12 is a flowchart illustrating operations for managing distributed workloads in an edge computing environment, according to an example;

FIG. 13 is a flowchart illustrating operations for coordinating attestation for a distributed workload executing in an edge computing environment, according to an example;

FIG. 14 illustrates an overview of an edge cloud configuration for edge computing, according to an example;

FIG. 15 illustrates deployment and orchestration for virtual edge configurations across an edge-computing system operated among multiple edge nodes and multiple tenants, according to an example;

FIG. 16 illustrates a vehicle compute and communication use case involving mobile access to applications in an edge-computing system, according to an example;

FIG. 17 illustrates a block diagram depicting deployment and communications among several Internet of Things (IOT) devices, according to an example;

FIG. 18 illustrates an overview of layers of distributed compute deployed among an edge computing system, according to an example;

FIG. 19 illustrates an overview of example components deployed at a compute node system, according to an example;

FIG. 20 illustrates a further overview of example components within a computing device, according to an example; and

FIG. 21 illustrates a software distribution platform to distribute software instructions and derivatives, according to an example.

### DETAILED DESCRIPTION

In the following description, methods, configurations, and related apparatuses are disclosed for implementation in a cloud-to-edge (C2E), cloud-native, or other cloud/edge compute-based framework. As used herein, “cloud-to-edge” generally refers to functionality to move workloads and capabilities that were traditionally located in a cloud computing setting towards distributed edge computing locations. Such functionality is particularly applicable to the deployment and execution of elastic workloads (WLs), which involve workloads that are distributed across multiple nodes, migrated, and dynamically coalesced.

Edge computing has introduced scenarios involving elastic workloads where a traditional monolithic workload, which may run on a single cloud or Edge node, may be decomposed into two or more sub-workloads that are distributed across multiple Edge nodes. The distributed workload may be partially or fully consolidated or decomposed even further to accommodate the changing resource dynamics of edge-cloud deployments for both stationary and mobile users and user equipment, or stationary and mobile edge nodes. These dynamics create an environment for elastic edge computing capabilities that include dynamic binding of workloads, resources, and compute.

The processing of distributed and elastic workloads can be further complicated by a number of security and trust requirements and considerations, as workloads are distributed among multiple locations and hardware resources. In particular, the use of attestation to validate a particular edge node (or a particular resource on a particular edge node) may introduce a significant processing overhead when many edge nodes and resources are involved. This is addressed by the techniques discussed herein to provide microservices for attestation using an attestation service mesh.

### Trusted Cloud-to-Edge Framework

The use of elastic WLs is designed to provide flexibility to accommodate distribution and dynamism inherent in edge computing. A dynamic C2E framework is needed to ensure that trust within a complex elastic WL infrastructure is preserved throughout the many types of WL configurations and use cases.

Existing container-as-a-service (CaaS), platform-as-a-service (PaaS), and infrastructure-as-a-service (IaaS) capabilities expect that trust is established statically at an initial deployment of a WL, and such capabilities generally will not re-evaluate trust during WL execution. The dynamics of an elastic WL in an C2E deployment, however, change the WL from being a monolithic WL to a distributed WL having dynamic properties that distribute the WL processing across multiple nodes. This is further complicated because nodes may dynamically migrate to other hosting environments at lower framework layers, resulting in broken trust semantics.

The systems and methods described herein implement an elastic WL framework with security and trust capabilities at operational layers involving workload execution environments (e.g., containers, virtual machines, etc.), platforms, and infrastructure, and these layers' associated services (Container-as-a-Service (CaaS), Platform-as-a-Service (PaaS), and Infrastructure-as-a-Service (IaaS)). The following systems and methods introduce a Trust Binding Manager to actively monitor and apply trust bindings between the artifacts at respective layers that require consistent trust properties, while responding to dynamic conditions that otherwise will break trust properties. This enables elastic WL frameworks to establish and preserve intended trust properties of a WL throughout the WL execution and lifecycle despite the occurrence of dynamic changes in resources, location, and data sources/sinks.

A trusted C2E services framework for elastic workloads is adapted as follows to ensure various “anything-as-a-service” (X-aaS) capabilities in a services framework. This is used to establish and maintain trust within the respective framework layers, e.g., CaaS, PaaS, and IaaS, and between C2E framework layering, e.g., CaaS to PaaS, and PaaS to IaaS. The Trust Binding Manager component is used to establish and maintain trust properties for an elastic WL that is implemented using a trusted C2E framework. The C2E framework integrates a Trust Binding Manager component that enables creation, simulation, deployment, and maintenance of trusted elastic WLs following a WL lifecycle.

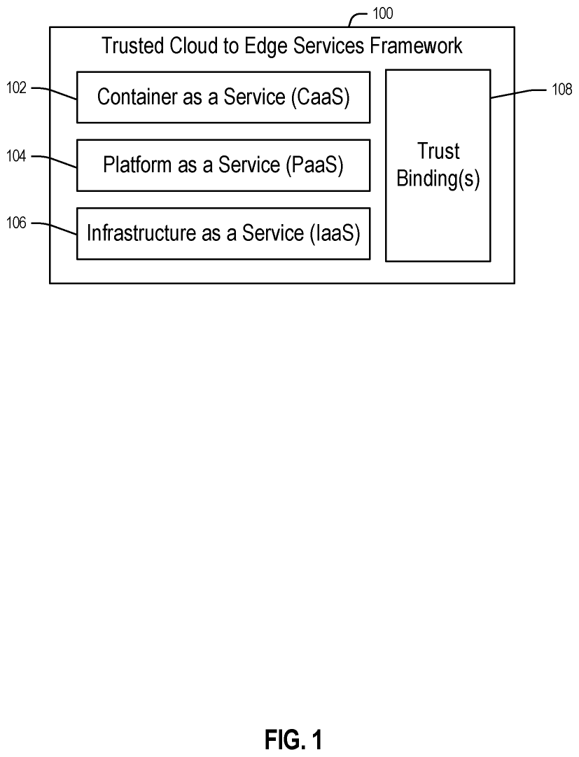

FIG. 1 is a block diagram illustrating an example of a trusted cloud-to-edge (C2E) services framework 100, according to an example. The trusted C2E services framework 100 includes a Container-as-a-Service (CaaS) layer 102, a Platform-as-a-Service (PaaS) layer 104, and an Infrastructure-as-a-Service (IaaS) layer 106, which are managed by using trust bindings 108. In other examples, a PaaS layer is operated above a CaaS layer, such as when the PaaS layer adds an application runtime layer over the container services.

The CaaS layer 102 creates a uniform abstraction for describing a workload that is independent of a particular platform. A distributed WL may partition the WL into logical sub-workloads that are related by a workflow model where the partial results from one sub-workload may be input to another sub-workload. The workflow may divide WL computations into execution operations that are in a particular sequence or in a particular concurrence. An individual sub-workload should have the same trust semantics as the monolithic WL. Monolithic WL trust may be established as part of an SLA (service level agreement) between the WL tenant and a WL service provider. Elastic WL execution may result in a distributed WL having multiple sub-workloads hosted by many nodes. The WL partitioning and execution workflow may introduce challenges to trust where the expected trust agreed to initially as part of an SLA agreement may disappear due to differences in platform and infrastructure options introduced by PaaS and IaaS framework layers.

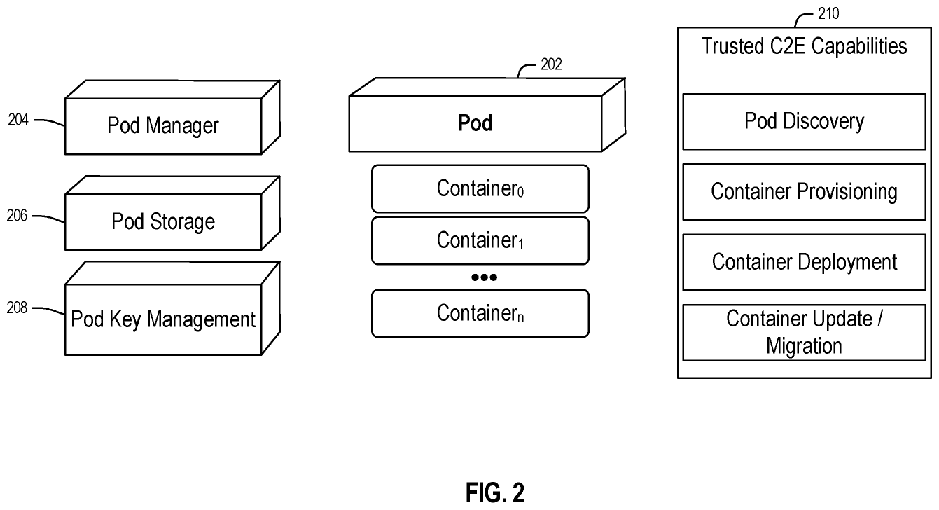

FIG. 2 is a block diagram illustrating the components of an example CaaS layer (e.g., corresponding to layer 102), according to an example. Here, a pod 202 is used to deploy multiple containers (labeled as container 0 to container n). Functionality used in the CaaS layer includes a pod manager 204, pod storage 206, and pod key management 208. The features discussed herein introduce the use of trusted C2E capabilities 210 for the CaaS layer, which include but are not limited to: pod discovery; container provisioning; container deployment; and container update or migration. Although references to a “pod” may refer the use of a pod in a Kubernetes deployment, other types of container management and container deployment systems may also be used.

Returning to FIG. 1, the PaaS layer 104 creates a uniform platform abstraction that facilitates workload deployment where the sub-workload fragments of a distributed workload execute within one or more virtual and physical platform environments. The PaaS layer 104 abstraction hides hardware, system software, and cloud platform specific artifacts so that the workload designer does not need to adapt the workload to differences found at lower layers. The PaaS layer 104 abstraction also hides trust properties inherent to lower layers resulting in workloads that ignore the risks associated with untrusted hosting environments. In general, PaaS may depend on additional infrastructure layers that may themselves have layer abstractions and packaged as services (e.g., IaaS, hardware-as-a-service (HWaaS), etc.). Workload designers may not be aware of the various deployment options available at infrastructure layers. The services ecosystem may outsource some or all of workload deployment to a services abstraction. Consequently, workload security policies may need to be adapted, translated, and negotiated to the specific security postures at respective infrastructure layers and with respective service providers.

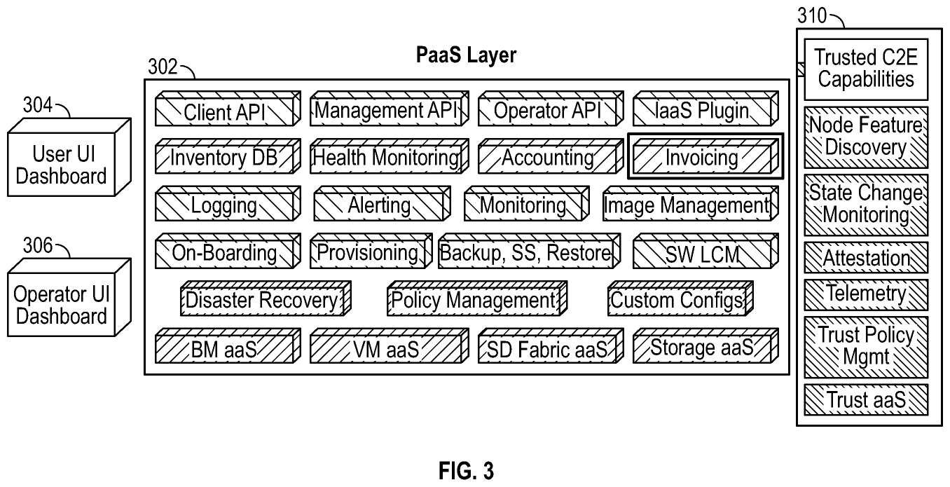

FIG. 3 is a block diagram illustrating the components of a PaaS layer (e.g., corresponding to layer 104), according to an example. Here, a PaaS layer 302 includes a variety of APIs, functions, and services to host and operate the platform. The PaaS layer 302 is operably coupled with a user (e.g., services user) dashboard UI 304 and an operator (e.g., administrator) dashboard UI 306 to invoke use of these APIs, functions, and services. The features discussed herein introduce the use of trusted C2E capabilities 310 for the PaaS layer, which include but are not limited to: node feature discovery; state change monitoring; attestation; telemetry; trust policy management; and trust services (e.g., in a “trust-as-a-service” or “TaaS” implementation). Other aspects such as an application runtime environment are not depicted for purposes of simplicity.

Returning to FIG. 1, the IaaS layer 106 creates a uniform interface for allocating WL resources, e.g., compute, memory, storage, and communication that satisfy expected performance and availability requirements as specified by an SLA. The infrastructure has physical security properties such as a hardware root of trust (RoT), secure storage for keys, trusted software, and protection of secret data. Mechanisms for discovering and attesting the trustworthiness properties of the IaaS resources need to be built into the IaaS infrastructure or trust in the upper C2E framework layers cannot be guaranteed.

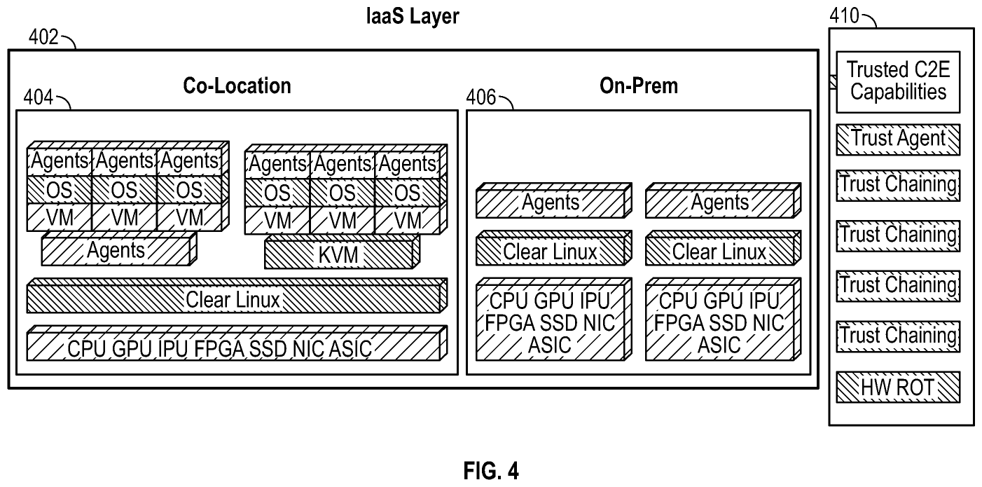

FIG. 4 is a block diagram illustrating the components of an IaaS layer (e.g., corresponding to layer 106), according to an example. The IaaS layer 402 of FIG. 4 depicts the use of co-located computing resources 404, and on-premise computing resources 406. A variety of types of computing scenarios involving virtual machines, operating systems, and hardware is also depicted. Although some specific types of operating systems (e.g., Linux) and hypervisors (e.g., KVM) are depicted, other types of operating systems and virtual machine monitors may be used. The features discussed herein introduce the use of trusted C2E capabilities 410 for the IaaS layer, which include but are not limited to: a trust agent; trust chaining (including multiple instances of such trust chaining); and a hardware root of trust.

The systems and methods described herein provide CaaS, PaaS, and IaaS layers with trusted computing capabilities that ensures the security and trust properties of the workload are represented and enforced at appropriate CaaS, PaaS, and IaaS layers. With use of the aforementioned trusted C2E capabilities, security and trust can be provided even if every infrastructure layer has an X-aaS abstraction.

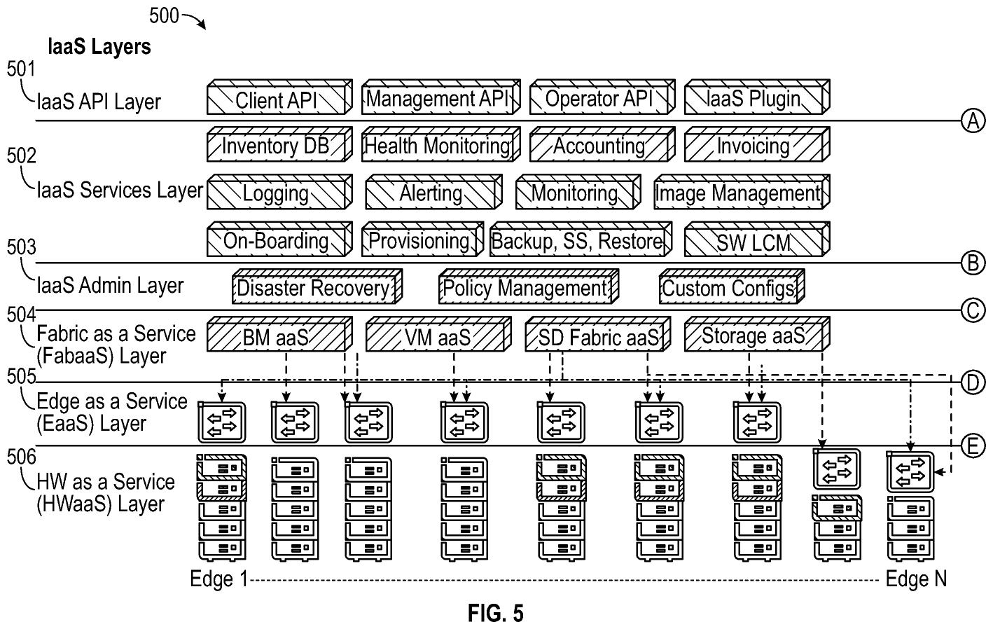

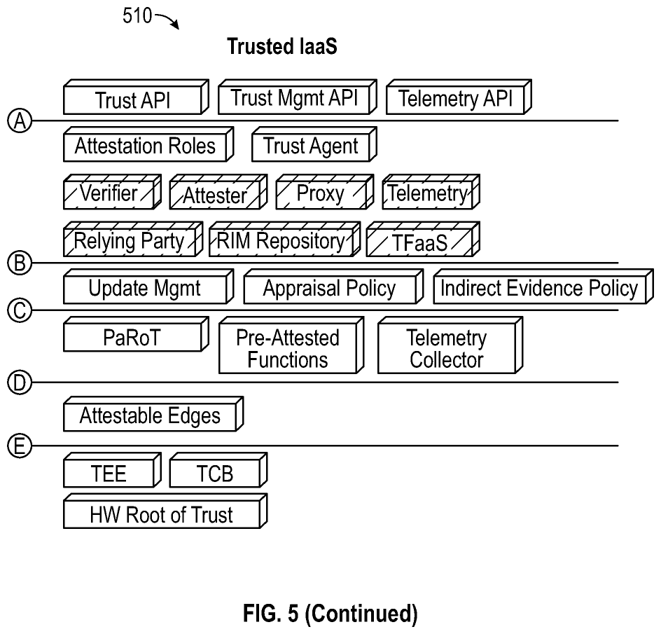

FIG. 5 is a block diagram illustrating additional aspects of IaaS layers and trust management capabilities, according to an example. The IaaS layers 500 depicted in FIG. 5 may include aspects such as: an API layer 501; a services layer 502; an admin layer 503; a Fabric-as-a-Service layer 504; an Edge-as-a-Service layer 505; and a Hardware-as-a-Service layer 506.

The IaaS layers 500 are adapted to provide trusted computing capabilities, using features of a trusted IaaS environment 510 that are supplied by trusted hardware. The relevant trusted computing capabilities include but are not limited to: HW roots of trust, trusted execution environments, security algorithm acceleration, network isolation, audit status, edge attestation, attestation evidence collector/lead attester (e.g., Open Compute Project Platform Active ROT, “PA ROT”), pre-attested functions, trusted telemetry collection, update management, appraisal policies, evidence policies, attestation ecosystem roles, and interfaces for the underlying trust, management, and telemetry capabilities.

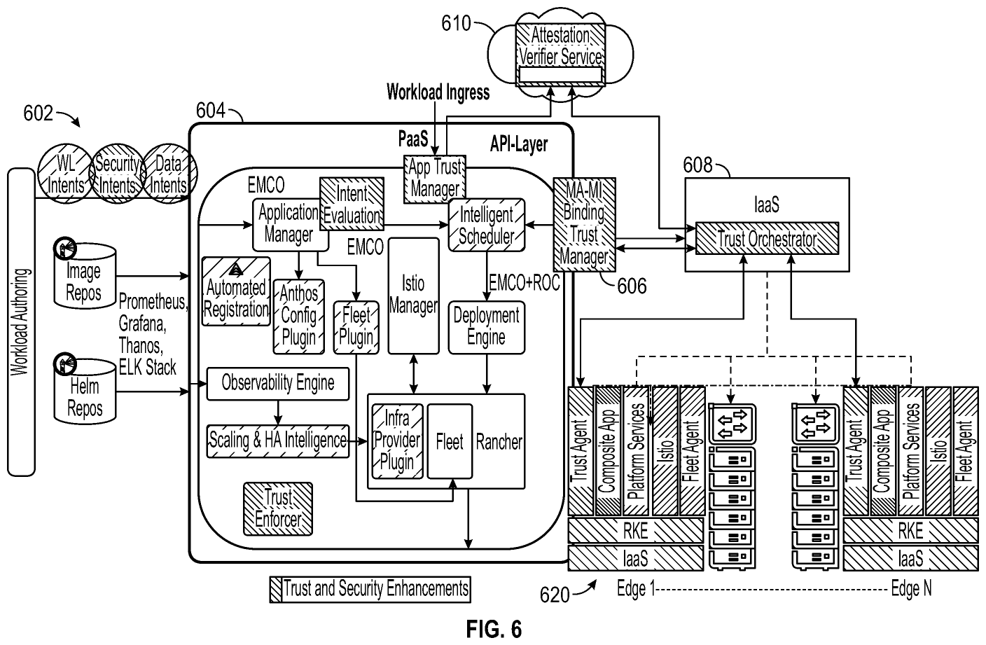

FIG. 6 is a block diagram illustrating a workflow of a workload, according to an example. The C2E framework provides trust capabilities that are also integrated in a PaaS layer 604, with the use of a trust binding manager 606. The trust binding manager 606 links trusted resources with trusted containers such that the binding between a container, platform, and resource is verifiable by another entity such as an attestation verifier service 610. This enables an IaaS layer 608 to successfully distribute the workloads to resources at one or more edge computing locations 620.

Trust in the container begins as part of workload authoring where the WL author supplies security intents and other intents metadata 602 that describes the parameters of trust such as expected attestation values and results. Workload authoring may also include elastic WL properties that aid in decomposing a monolithic WL into distributable parts using metadata in the form of WL intents, security intents, and data intents. This metadata may describe expected or allowed WL, module, and data composition/decomposition points as well as data ingress/egress behavior for WL nodes that optimize for remote data hosting with data flow ingress/egress. Additionally, data sensitivities are described by metadata that include policies that describe safe HW and SW environments where sensitive data may be safely and confidentially manipulated such as Intel® SGX/TDX, ARM® TrustZone, AMD® SEV, etc.

### Attestation Microservices and Service Mesh for Elastic Workloads

Many attestation services are based on a centralized deployment model where workload (WL) computing nodes request attestation following a passport model. In such settings, the passport may be presented to WL orchestrators who vet the computing node and schedule the WL as appropriate. In elastic computing scenarios, however, WL nodes are not static. Portions of a WL may be dynamically partitioned where WL partitions are also dynamically provisioned to a microservices hosting node. For instance, consider a scenario where a respective microservice (also referred to as a “μService”) obtains a passport (e.g., token) from an attestation verification service, which results in O(n log n) to O(n\hat{ }2) latency overhead. In this scenario, n is the number of microservice partitions as a microservice cross-checks the other n microservices. This does not scale well for cloud-to-edge/cloud-native execution infrastructures.

Other approaches may rely on a cloud service abstraction that centralizes attestation processing as a service abstraction. The cloud services provider may scale the service by adding resources to the server backplane. This approach does not address edge network environments that typically have compute dispersed at different locations with differing compute, connectivity, resource, and latency properties. As noted above, centralized attestation services, e.g., hosted in a cloud, also introduce latency in an edge network.

The following system and methods integrate an attestation mesh into an edge computing mesh that optimizes the execution of edge WLs. In an example, this optimization is provided by co-locating Function-as-a-Service (FaaS) functions on hardware such as infrastructure processing units (IPUs) or similar data processing units (DPUs) that are also hosting a distributed WL. The attestation WL is then decomposed into FaaS functions for easy co-location with the other WL/FaaS mesh execution locations. The various stages of attestation processing may rely on attestation inputs, e.g., evidence, reference values, endorsed values, and policies, which are supplied by support services but may be cached locally by the hardware (e.g., IPUs, DPUs) of a mesh node. As used herein, references to an IPU or DPU generally refer to a packet processing or network interface circuitry (and accompanying processor, memory, DMA engine, etc.) that is enabled to perform some execution operation or function at the network level (e.g., at a SmartNIC or network interface) including performing such operations or functions directly on network-received data.

In an attestation service mesh, a respective node may perform any/all of the duties of an attestation system including but not limited to: collecting and signing evidence, issuing endorsement or reference value manifests and certificates, generating attested attribute requests, creating a view of attester attestation states that satisfies interest requests, and the like. An attestation service mesh may propagate an interest from one mesh node to another until attestation claims are discovered that satisfy the interest. Accordingly, an attestation service mesh may propagate evidence, endorsements, and reference values from one mesh node to another until an appraisal process can be completed.

This approach allows attestation appraisals to occur within the latency envelope that is appropriate for the edge workload node. More frequent or timely attestation appraisals can be performed because the mesh node with attestation support can cache the various appraisal inputs and manage the cache along with the other mesh-aware WL caching policy.

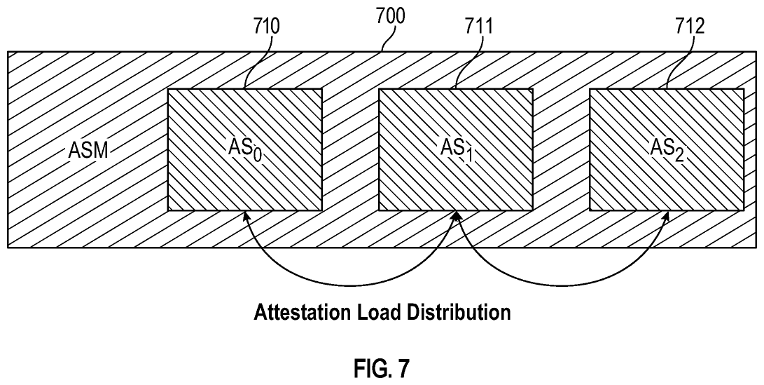

FIG. 7 is a block diagram illustrating attestation load distribution, according to an example. An attestation service mesh (ASM) 700 is a cluster of attestation service nodes that cooperate to distribute attestation workloads associated with a distributed or decentralized elastic WL. A respective Attestation Service (AS) (shown with AS instances 710, 711, 712) may be provided by a respective microservice that specializes in attestation verification processing. A respective AS may be further divided into FaaS functions that specialize in implementation of an aspect of attestation verification processing (e.g., certificate path construction, reference integrity manifest (RIM) location/collection, document signature verification, trust anchor repository access (per tenant), document format decoding, evidence collection, evidence integrity verification, evidence format decoding, tag lifecycle management, appraisal, attestation results creation, attestation results integrity protection, or attestation results creation/passport/token issuance and delivery). As an attestation microservice, these functions can be elastically hosted on/near elastic WL nodes.

Thus, the ASM 700 may be hosted on the same infrastructure nodes that are used to host (e.g., execute) decentralized elastic WLs. The elastic and ASM WLs may be implemented as different tenants utilizing hardware and software isolation techniques including OS process isolation, containers, micro-kernels, virtual memory, processor operational modes, virtualization, or physical and virtual segmentation, such as with use of technologies such as Intel® SGX, Intel® TDX, AMD® Secure Encrypted Virtualization (SEV), ARM® TrustZone and so forth. The ASM microservices (AS0, AS1, . . . , ASn, shown with instances 710, 711, 712) are provisioned with cryptographic identities, credentials, and policies that establish them as a trusted group within the ASM 700. The ASM microservices maintain cross-connections that may be utilized to quickly offload attestation processing functions and to share (e.g., using a cache) various attestation-related data including endorsement manifests, reference value manifests, device certificates, device sessions (e.g., SPDM, RA-TLS, Attested TLS, or HTTP-Attest), device decentralized identifiers (DID), tokens (e.g., OAuth2, OpenID-Connect, IETF EAT, IETF JWT, or IETF CWT), D-WL policies such as SLAs, SLOs, trust anchors, security policy, security settings, intermediate attestation results, final attestation results (AR), audit information, telemetry information and any other data that may be generated as a result of operating a robust ASM.

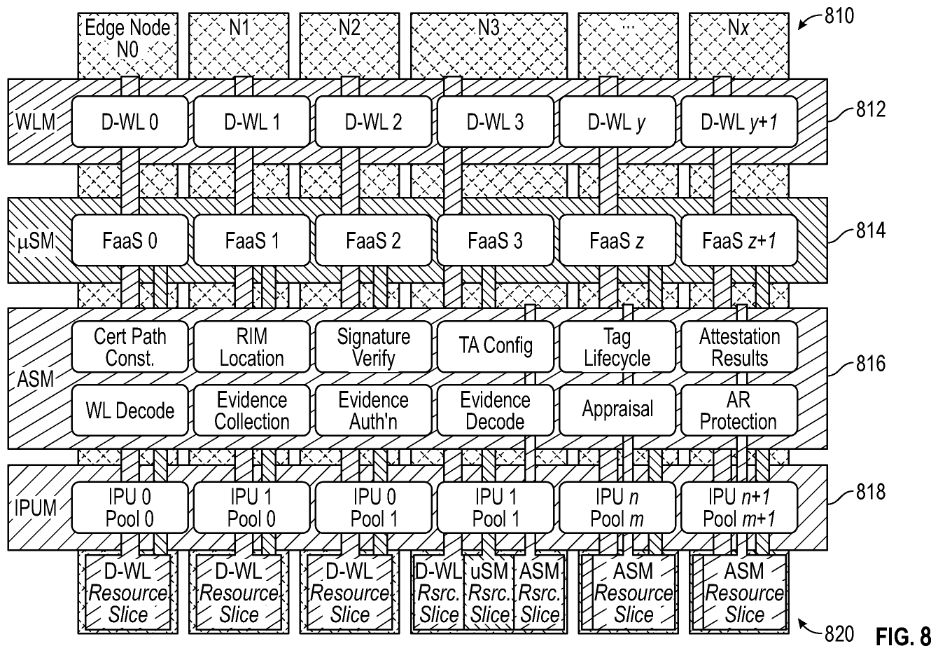

FIG. 8 is a block diagram illustrating an elastic workload mesh architecture, according to an example. The elastic workload may be distributed across multiple nodes 810 (numbered NO to Nx) forming a workload mesh (WLM 812). The WLM functions as a cohesive platform for executing a WL, but is distributed or decentralized in terms of the logical, virtual, or physical processing nodes that are actually used to execute. The WLM 812 may rely on a set of WL metadata that describes the WL functions, data, partitioning semantics and may have specified quality, performance, trust, security, resiliency, privacy, and availability requirements. The WLM 812 also may support multiple WLs per infrastructure node 810 using tenant isolation techniques as described herein.

The WLM 812 may interface with a microservice mesh (μSM 814) that implements and deploys popular FaaS functions commonly used (e.g., invoked) across multiple WLs. The μSM 814 may be implemented on the same infrastructure nodes as other mesh capabilities including WLM 812, ASM 816, and so forth. The μSM FaaS functions are isolated using tenant isolation technology as described herein.

The μSM 814 may interface with an attestation service mesh (ASM 816), which may perform a variety of functions for attestation services, as discussed above. These functions, as depicted, may include security- or attestation-related operations related to: certificate path construction; RIM location; signature verification; trust anchor (TA) configuration; tag lifecycle; attestation results; workload decoding; evidence collection; evidence authentication; evidence decoding; appraisal; and attestation results (AR) protection.

Infrastructure nodes may be hosted or coordinated by an infrastructure processor unit mesh 818 (IPUM) that maintains pools for compute resources configured to host mesh-based workloads (as described above) that are optimized for efficient edge operation. For example, a pool of IPUs may be integrated on a common backplane, rack, cluster, geo-location network, etc., having memory, storage, acceleration, and network connectivity resources readily available for pool IPU consumption. IPU pools may be connected for efficient resource sharing, load balancing, and resiliency, including for respective resource slices 820.

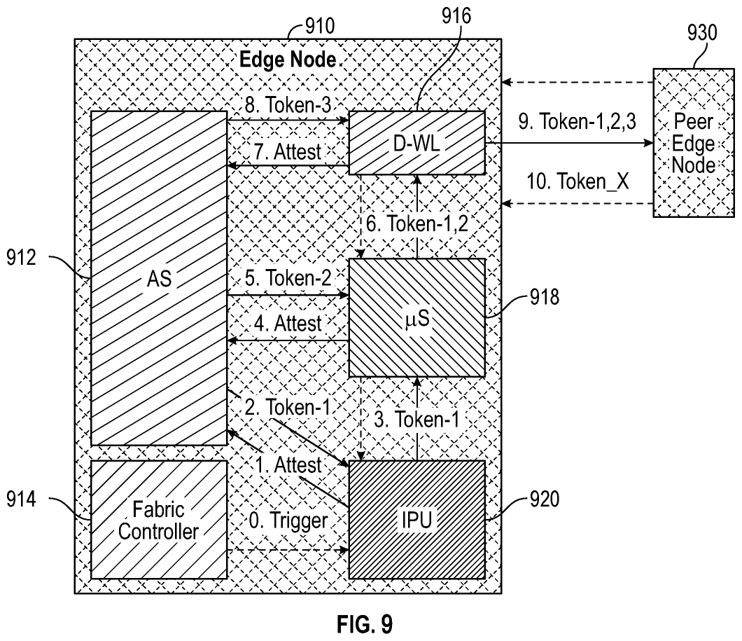

FIG. 9 is a block diagram illustrating attestation of a distributed workload using an attestation mesh, according to an example. A respective cross-section of an edge node 910 and mesh layer (as illustrated in FIG. 8) may be used to attest the resource to an AS microservice 912 in the ASM as a condition of participation in the mesh and as a condition of participation in a D-WL vertical stack (such as for D-WL 916 as illustrated in FIG. 9). An IPU 920 (or similar edge processing unit) may utilize a Fabric Controller 914 (FC) that is responsible for triggering attestation of an IPU resource upon appropriate events such as power reset, system reset, fault or interrupt handling, microcode update, firmware update, failure event, and so forth. The FC trigger (operation 0) results in at least the IPU 920 requesting attestation by an Attestation Service (AS) (operation 1), such as an AS microservice 912 that is assigned to the IPU 920, which results in a verification on the IPU 920. Although this example configuration specifically refers to the use of a microservice, it will be understood that similar types of functions, function chains, and distributed/segmented service and execution components may be provided instead of (or in addition to) a microservice.

An attestation result in the form of an attestation token (operation 2) may utilize industry standard token structures such as CBOR Web Token, JSON Web Token, Concise Evidence, W3C DID/VC, X.509 certificates, Trusted Platform Module, or proprietary formats such as an Intel® SGX attestation block, etc. The attestation token may be returned to the IPU 920 upon successful verification and appraisal (e.g., as outlined in an IETF RATS Architecture (RFC9334), which provides an example approach of attestation appraisal). The token may be presented to another mesh layer node such as a WL FaaS μService 918 in response to a request to obtain IPU resources or in response to other events that bind WL hosting resources. The token (e.g., token-1, communicated in operation 3) may contain the AS issue attestation result, a token validity period, policies for proper use, additional security-related attributes including authentication credentials, authorization policies, an audit policy, access control rules, and so forth. The token may be evaluated by the μService 918 to facilitate binding the μService layer resources to the IPU layer resources. It may also be supplied with an attestation payload to an AS microservice 912 (operation 4) to request an attestation token describing the μService node. The token-2 (communicated in operation 5) may contain token-1 to form a composite token, Token-1,2 (to be communicated in operation 6, discussed below).

The composite token may be issued by an AS microservice 912 by verifying attestation evidence supplied by the μService 918 and may include evaluation of the lower layer token (e.g., token-1). Verification of token-1 may suffice for establishing attestation properties as a performance optimization that avoids unnecessarily re-attesting the IPU resource. A distributed workload (D-WL 916) may trigger a FaaS μService attestation as part of a request to perform the μFunction. The μService 918 may return an attestation token (operation 6) that contains attestation results for the μService 918 and IPU layered resources to the D-WL 916 (operation 7).

The D-WL 916 may be expected to coordinate with a peer D-WL node, where coordination/interaction is contingent on obtaining an attestation token. The D-WL 916 may obtain an attestation token-3 (operation 8). The attestation request may include lower layer attestation tokens (token-1,2) in addition to D-WL collected evidence. The AS microservice 912 may evaluate D-WL evidence and verify the lower layer tokens' attestation results rather than re-attesting lower layers. Although, such re-attestation may be performed if there is reason to question the validity of the token such as if the token expiration has been exceeded. The D-WL 916 may receive another composite token-1,2,3 (operation 9) that is supplied to a peer Edge node 930 in response to a request to receive such token or as a parameter to an edge API (such as a RESTful web interface) as a condition of interaction with the peer node. The peer node may be required by the D-WL 916 (or indirectly by the AS microservice 912 supporting the D-WL 916) to attest the peer node (operation 10). In this manner, bilateral attestation may be accomplished by peer D-WL nodes.

A WLM may elastically increase/decrease the number of nodes in the distributed workload resulting in inaccurate attestation tokens. However, fully (exhaustively) re-attesting every D-WL and all the layers to the IPU/root-of-trust may not be required. Only the configurations affected by D-WL manipulation need to be re-issued.

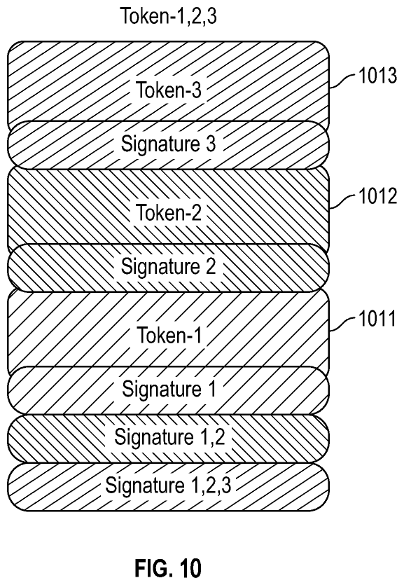

FIG. 10 is a block diagram illustrating an attestation mesh token structure, according to an example. The token structure contains separate sections 1011, 1012, 1013 for attestation results relating to disparate attestation verification requests where a respective verification is recorded and digitally signed separately. Hence, these results can be dismantled and reconstructed accordingly to represent the current composition (or re-composition) of the WL/D-WL.

For instance, in FIG. 10, first IPU resource attestation results are shown as token-1 1011 with an associated token signature, Signature 1. A second attestation token is shown as token-2 1012 with attestation results for a μService module, and an associated signature, Signature 2. Additionally, a Signature 1,2 is added that establishes the binding between μService and IPU layers. Similarly, for the D-WL layer, a token-1,2,3 is represented showing a third layer token as token-3 1013, having a Signature 3, plus a Signature 1,2,3 indicating the binding across the three layers. Signature 1,2 and Signature 1,2,3 may counter-sign signatures 1, 2, or 3 respectively as a way to assert the discrete tokens were verified and processed according to a workflow such as is described by FIG. 9.

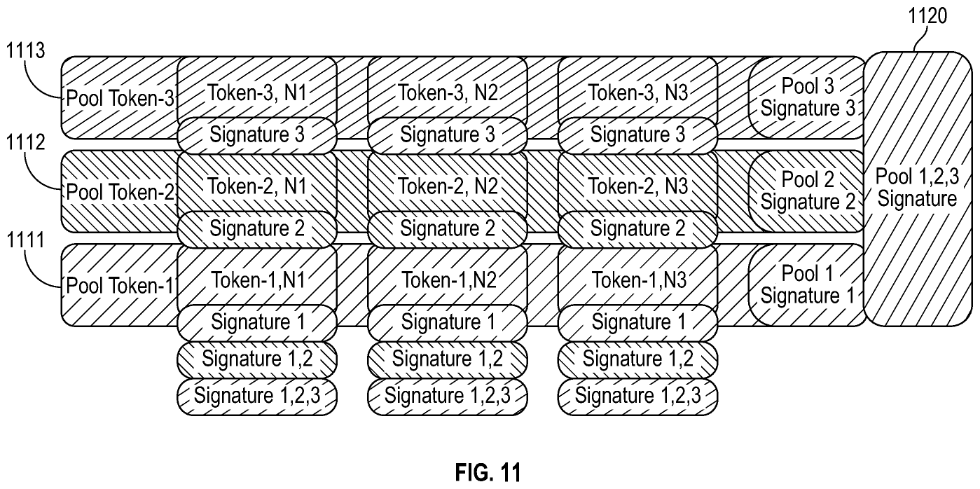

FIG. 11 is a block diagram illustrating a fully articulate attestation mesh token, according to an example. The WLM, USM, and IPUM mesh layers can function as a pool of resources that may be used in various ways to achieve greater operational efficiency, availability, and resiliency. The attestation token structure supports such scenarios by grouping pools of mesh layer resources having pre-computed attestation results for a respective pool member. For example, an IPU mesh consisting of a first IPU node may have attestation results represented by (token-1,N1). A second IPU node may have attestation results represented by (token-1,N2) and so forth. The pool of attestation results may be authenticated by a pool signature, Pool 1, Signature 1. Similarly, other mesh pools may have pooled tokens following a similar convention. A token may represent fully an attested mesh of a deployed workload as depicted by a token consisting of a Pool 1,2,3 token signed by a signature across the pools 1111, 1112, 1113 (horizontally) and across the layers (vertically) that may be used to efficiently verify a single token signature 1120.

If the mesh deployments are static (e.g., do not contain changes that trigger re-issuance of any sub-token) then the ‘Pool Token 1,2,3’ may be reused by any node in the pool/mesh to satisfy attestation checking requirements by checking a single signature and singleton token properties.

The pool-token for attestation (and other token forms) described herein may contain additional attributes for Authentication, Authorization, Audit, or Access control (in addition to Attestation). The token may be referred as an AAAA or “A4” token or “A5” token respectively. As such, the A4/A5 token may be supplied with a variety of network interfaces in Edge, Cloud, and Decentralized Application deployments having minimal impact to API/interface design. The token may be passed directly over the interface or a reference to the token given where the receiver may obtain the token out-of-band. The token may be realized using existing standard token structures including W3C DID, CWT, JWT, XML-DSIG, CMS, and others.

### Implementation Examples

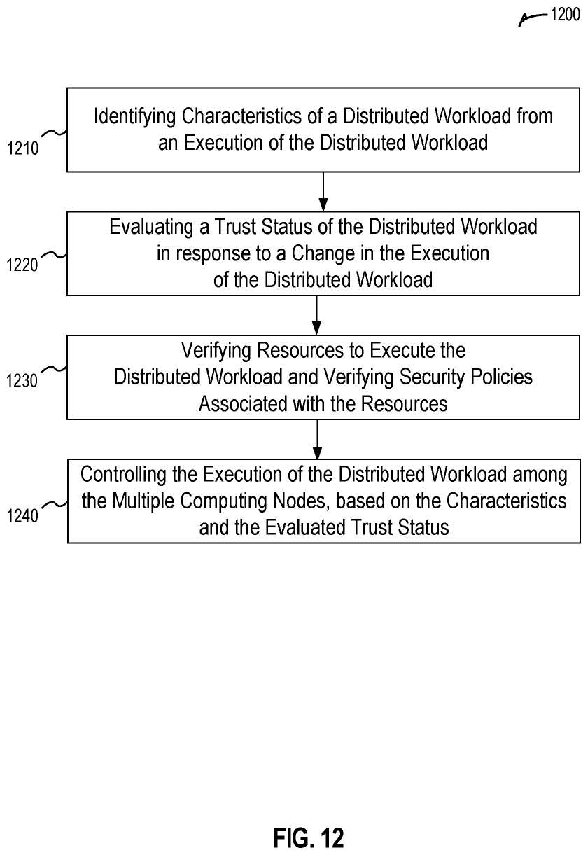

FIG. 12 is a flowchart illustrating operations for managing distributed workloads in an edge computing environment, according to an example.

Operation 1210 includes identifying characteristics of a distributed workload from an ongoing execution of the distributed workload. As discussed in the examples above, a distributed workload may include a workload that is partitioned among multiple computing nodes for processing and/or execution. In a specific example, the multiple computing nodes are provided by a platform-as-a-service (PaaS) configuration, and the operations of the computing system are coordinated by an infrastructure-as-a-service (IaaS) configuration to execute the distributed workload, such that the IaaS configuration provides a uniform interface for allocating trusted resources to the distributed workload. In another specific example, the multiple computing nodes are provided by a cloud repository infrastructure, and the cloud repository infrastructure operates a trusted repository cloud agent service to verify operations that execute the distributed workload.

Operation 1220 includes evaluating a trust status of the distributed workload, using the identified characteristics, in response to a change in the execution of the distributed workload. In a specific example, operations for evaluating the trust status may be performed by a trust coordination framework service and/or the attestation services discussed above. Also in a specific example, the characteristics of the distributed workload include expected trust properties to exist between a workload execution environment and respective infrastructure resources. These expected trust properties are used to enable control of the execution of the distributed workload based on use of a token, passport, or other credential that includes metadata to describe the expected trust properties.

Operation 1230 includes verifying resources to execute the distributed workload and verifying security policies associated with the resources. Additional operations for evaluating the trust status (including from attestation results) and verifying the resources may be performed as discussed in the various examples above.

Operation 1240 includes controlling the execution of the distributed workload among the multiple computing nodes, based on the characteristics and the evaluated trust status. This may include various aspects of workload execution and management operations.

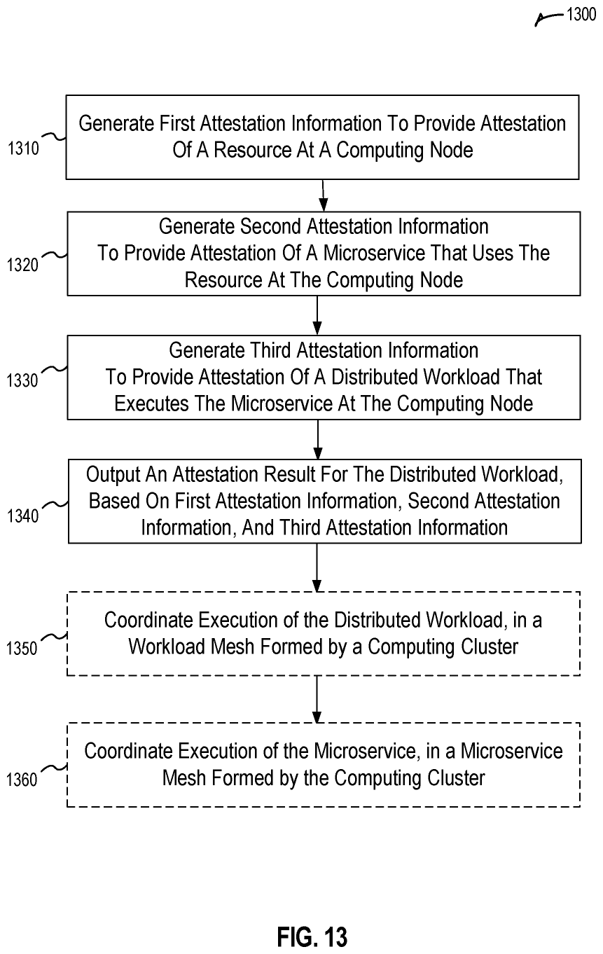

FIG. 13 is a flowchart illustrating operations for adapting execution of distributed workloads in an edge computing environment, in connection with an attestation services mesh. In some examples, these operations may be optionally performed, performed in another order, or repeated based on the examples provided above.

Operation 1310 includes generating first attestation information (e.g., with an attestation service operating at a computing node), to provide attestation of a resource at a computing node. In an example, the computing node is one of a plurality of nodes in a computing cluster, and the following attestation result that is generated is provided to another computing node of the plurality of nodes in connection with attestation for the distributed workload. For example, all of the plurality of nodes in the computing cluster may include respective attestation services to provide an attestation service mesh, where the respective attestation services are coordinated throughout the attestation service mesh to distribute separate (e.g., different) functions for the attestation of the distributed workload. This attestation service mesh may include various functions for the collection of evidence, verification/appraisal of evidence, endorsements, and reference values, and generation of a view of accepted claims that are relevant to a relying party (such as a peer distributed workload node).

Operation 1320 includes generating second attestation information (e.g., with the attestation service operating at the computing node), to provide attestation of a microservice (or another type of function, function chain, executable component, etc.) that uses the resource at the computing node. In an example, the resource at the computing node may include at least one of: an infrastructure computing unit, a central processing unit (CPU), a graphics processing unit (GPU), or an accelerator. The use of an accelerator may also include a cryptographic or security accelerator associated with a microservice, and the use of single root input/output virtualization (SR-IOV) scalable virtualization.

Operation 1330 includes generating third attestation information (e.g., with the attestation service operating at the computing node), to provide attestation of a distributed workload that executes the microservice at the computing node. Any arbitrary number of resources, microservices, and attestations may be performed in connection with the attestation service mesh and the attestation of the distributed workload, to create a complete chain of trust.

The attestation service and the distributed workload may be separated as different tenants within the computing node, based on hardware and software isolation. In a scenario where a computing cluster is used, the execution of the distributed workload may be coordinated by a workload mesh formed by the computing cluster, and the execution of the microservice may be coordinated by a microservice mesh formed by the computing cluster.

Operation 1340 includes outputting an attestation result for the distributed workload, based on the first attestation information, the second attestation information, and the third attestation information. In an example, the attestation result is a composite token, and the composite token includes the first attestation information and an associated first signature, the second attestation information and an associated second signature, and the third attestation information and an associated third signature (e.g., as shown in FIGS. 10 and 11). In another example, the first attestation information is provided in a first token, the second attestation information is provided in a second token, and the third attestation information is provided in a third token, and: the first token is generated in response to a first attestation request from the resource, the second token is generated in response to a second attestation request from the microservice, and the third token is generated in response to a third attestation request from the distributed workload (e.g., as shown in FIG. 9).

In example, the attestation service includes a plurality of functions that implement attestation verification processing, such as with use of functions provided from among: certificate path construction, reference integrity manifest (RIM) management, signature verification, trust anchor management, evidence management, tag lifecycle management, attestation results creation, attestation results integrity protection, or attestation results issuance. Other examples discussed above may also be provided.

Operation 1350 includes optionally coordinating execution of the distributed workload, such as in a workload mesh formed by a computing cluster (e.g., with peer edge nodes). Operation 1360 includes optionally coordinating execution of the microservice, in a microservice mesh formed by the computing cluster.

Other operations (not depicted) may include performing particular remedial and preventative operations when attestation is not successfully accomplished or performed. This may include quarantining resources, denying or rejecting services, or performing other remedial actions in response to a failure to attest the resource, the microservice, and/or the distributed workload.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a computing node configured to coordinate attestation for a distributed workload, comprising: processing circuitry; and a memory device including instructions embodied thereon, wherein the instructions, which when executed by the processing circuitry, configure the processing circuitry to cause operations that: generate, with an attestation service, first attestation information to provide attestation of a resource at the computing node; generate, with the attestation service, second attestation information to provide attestation of a microservice at the computing node, the microservice to use the resource at the computing node; generate, with the attestation service, third attestation information to provide attestation of a distributed workload, the distributed workload to execute the microservice at the computing node; and output an attestation result for the distributed workload, based on the first attestation information, the second attestation information, and the third attestation information.

In Example 2, the subject matter of Example 1 optionally includes wherein the attestation result is a composite token, the composite token including the first attestation information and an associated first signature, the second attestation information and an associated second signature, and the third attestation information and an associated third signature.

In Example 3, the subject matter of any one or more of Examples 1-2 optionally include wherein the first attestation information is provided in a first token, wherein the second attestation information is provided in a second token, and wherein the third attestation information is provided in a third token.

In Example 4, the subject matter of Example 3 optionally includes wherein the first token is generated in response to a first attestation request from the resource, wherein the second token is generated in response to a second attestation request from the microservice, and wherein the third token is generated in response to a third attestation request from the distributed workload.

In Example 5, the subject matter of any one or more of Examples 1-4 optionally include wherein the computing node is one of a plurality of nodes in a computing cluster, and wherein the attestation result is provided to another computing node of the plurality of nodes in connection with attestation for the distributed workload.

In Example 6, the subject matter of Example 5 optionally includes wherein the plurality of nodes in the computing cluster include respective attestation services to provide an attestation service mesh, wherein the respective attestation services are coordinated in the attestation service mesh to distribute separate functions for the attestation of the distributed workload.

In Example 7, the subject matter of any one or more of Examples 5-6 optionally include wherein execution of the distributed workload is coordinated by a workload mesh formed by the computing cluster, and wherein execution of the microservice is coordinated by a microservice mesh formed by the computing cluster.

In Example 8, the subject matter of any one or more of Examples 1-7 optionally include wherein the attestation service includes a plurality of functions that implement attestation verification processing, the plurality of functions provided from among: certificate path construction, reference integrity manifest (RIM) management, signature verification, trust anchor management, evidence management, tag lifecycle management, attestation results creation, attestation results integrity protection, or attestation results issuance.

In Example 9, the subject matter of any one or more of Examples 1-8 optionally include wherein the attestation service and the distributed workload are separated as different tenants within the computing node, based on hardware and software isolation.

In Example 10, the subject matter of any one or more of Examples 1-9 optionally include wherein the resource at the computing node includes at least one of: an infrastructure computing unit, a central processing unit (CPU), a graphics processing unit (GPU), or an accelerator.

Example 11 is at least one non-transitory machine-readable storage medium comprising instructions stored thereupon, which when executed by processing circuitry of a computing node, cause the processing circuitry to: generate, with an attestation service, first attestation information to provide attestation of a resource at the computing node; generate, with the attestation service, second attestation information to provide attestation of a microservice at the computing node, the microservice to use the resource at the computing node; generate, with the attestation service, third attestation information to provide attestation of a distributed workload, the distributed workload to execute the microservice at the computing node; and output an attestation result for the distributed workload, based on the first attestation information, the second attestation information, and the third attestation information.

In Example 12, the subject matter of Example 11 optionally includes wherein the attestation result is a composite token, the composite token including the first attestation information and an associated first signature, the second attestation information and an associated second signature, and the third attestation information and an associated third signature.

In Example 13, the subject matter of any one or more of Examples 11-12 optionally include wherein the first attestation information is provided in a first token, wherein the second attestation information is provided in a second token, and wherein the third attestation information is provided in a third token.

In Example 14, the subject matter of Example 13 optionally includes wherein the first token is generated in response to a first attestation request from the resource, wherein the second token is generated in response to a second attestation request from the microservice, and wherein the third token is generated in response to a third attestation request from the distributed workload.

In Example 15, the subject matter of any one or more of Examples 11-14 optionally include wherein the computing node is one of a plurality of nodes in a computing cluster, and wherein the attestation result is provided to another computing node of the plurality of nodes in connection with attestation for the distributed workload.

In Example 16, the subject matter of Example 15 optionally includes wherein the plurality of nodes in the computing cluster include respective attestation services to provide an attestation service mesh, wherein the respective attestation services are coordinated in the attestation service mesh to distribute separate functions for the attestation of the distributed workload.

In Example 17, the subject matter of any one or more of Examples 15-16 optionally include wherein execution of the distributed workload is coordinated by a workload mesh formed by the computing cluster, and wherein execution of the microservice is coordinated by a microservice mesh formed by the computing cluster.

In Example 18, the subject matter of any one or more of Examples 11-17 optionally include wherein the attestation service includes a plurality of functions that implement attestation verification processing, the plurality of functions provided from among: certificate path construction, reference integrity manifest (RIM) management, signature verification, trust anchor management, evidence management, tag lifecycle management, attestation results creation, attestation results integrity protection, or attestation results issuance.

In Example 19, the subject matter of any one or more of Examples 11-18 optionally include wherein the attestation service and the distributed workload are separated as different tenants within the computing node, based on hardware and software isolation.

In Example 20, the subject matter of any one or more of Examples 11-19 optionally include wherein the resource at the computing node includes at least one of: an infrastructure computing unit, a central processing unit (CPU), a graphics processing unit (GPU), or an accelerator.

Example 21 is a method performed by a computing node for coordinating attestation with a distributed workload, comprising: generating, with an attestation service, first attestation information to provide attestation of a resource at the computing node; generating, with the attestation service, second attestation information to provide attestation of a microservice at the computing node, the microservice to use the resource at the computing node; generating, with the attestation service, third attestation information to provide attestation of a distributed workload, the distributed workload to execute the microservice at the computing node; and outputting an attestation result for the distributed workload, based on the first attestation information, the second attestation information, and the third attestation information.

In Example 22, the subject matter of Example 21 optionally includes wherein the attestation result is a composite token, the composite token including the first attestation information and an associated first signature, the second attestation information and an associated second signature, and the third attestation information and an associated third signature.

In Example 23, the subject matter of any one or more of Examples 21-22 optionally include wherein the first attestation information is provided in a first token, wherein the second attestation information is provided in a second token, and wherein the third attestation information is provided in a third token.

In Example 24, the subject matter of Example 23 optionally includes wherein the first token is generated in response to a first attestation request from the resource, wherein the second token is generated in response to a second attestation request from the microservice, and wherein the third token is generated in response to a third attestation request from the distributed workload.

In Example 25, the subject matter of any one or more of Examples 21-24 optionally include wherein the computing node is one of a plurality of nodes in a computing cluster, and wherein the attestation result is provided to another computing node of the plurality of nodes in connection with attestation for the distributed workload.

In Example 26, the subject matter of Example 25 optionally includes wherein the plurality of nodes in the computing cluster include respective attestation services to provide an attestation service mesh, wherein the respective attestation services are coordinated in the attestation service mesh to distribute separate functions for the attestation of the distributed workload.

In Example 27, the subject matter of any one or more of Examples 25-26 optionally include wherein execution of the distributed workload is coordinated by a workload mesh formed by the computing cluster, and wherein execution of the microservice is coordinated by a microservice mesh formed by the computing cluster.

In Example 28, the subject matter of any one or more of Examples 21-27 optionally include wherein the attestation service includes a plurality of functions that implement attestation verification processing, the plurality of functions provided from among: certificate path construction, reference integrity manifest (RIM) management, signature verification, trust anchor management, evidence management, tag lifecycle management, attestation results creation, attestation results integrity protection, or attestation results issuance.

In Example 29, the subject matter of any one or more of Examples 21-28 optionally include wherein the attestation service and the distributed workload are separated as different tenants within the computing node, based on hardware and software isolation.

In Example 30, the subject matter of any one or more of Examples 21-29 optionally include wherein the resource at the computing node includes at least one of: an infrastructure computing unit, a central processing unit (CPU), a graphics processing unit (GPU), or an accelerator.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

### Overview of Edge Computing Environments

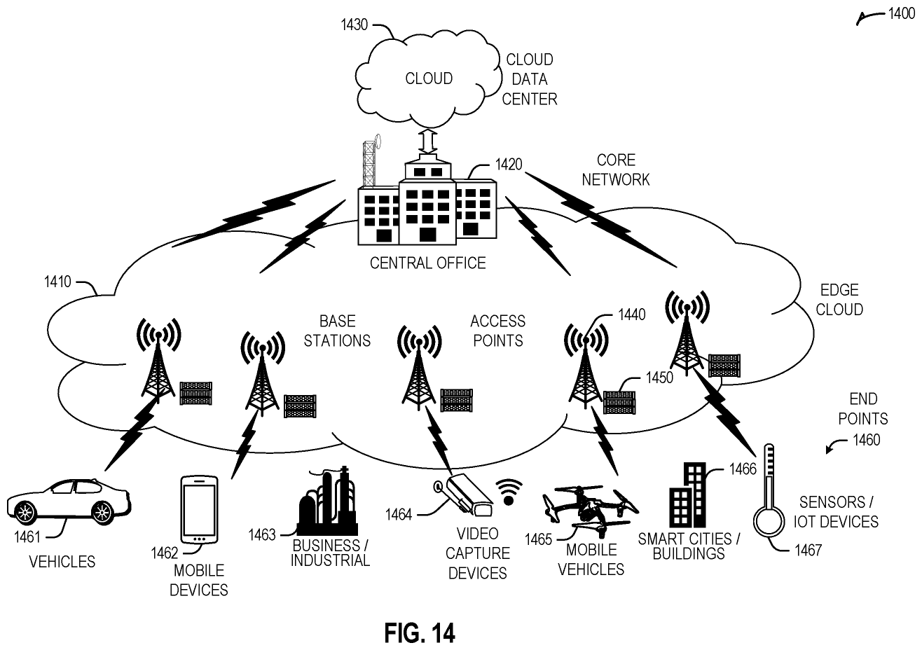

FIG. 14 is a block diagram 1400 showing an overview of a configuration for edge computing, which includes a layer of processing referenced in many of the current examples as an “edge cloud.” As shown, the edge cloud 1410 is co-located at an edge location, such as an access point or base station 1440, a local processing hub 1450, or a central office 1420, and thus may include multiple entities, devices, and equipment instances. The edge cloud 1410 is located much closer to the endpoint (consumer and producer) data sources 1460 (e.g., autonomous vehicles 1461, user equipment 1462, business and industrial equipment 1463, video capture devices 1464, mobile vehicles (e.g., drones) 1465, smart cities and building devices 1466, sensors and IoT devices 1467, etc.) than the cloud data center 1430. Compute, memory, and storage resources which are offered at the edges in the edge cloud 1410 are critical to providing ultra-low latency response times for services and functions used by the endpoint data sources 1460 as well as reduce network backhaul traffic from the edge cloud 1410 toward cloud data center 1430 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 14, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data center-based storage and processing. Key performance indicators (KPIs) may be used to identify where sensor data is appropriately transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data center.

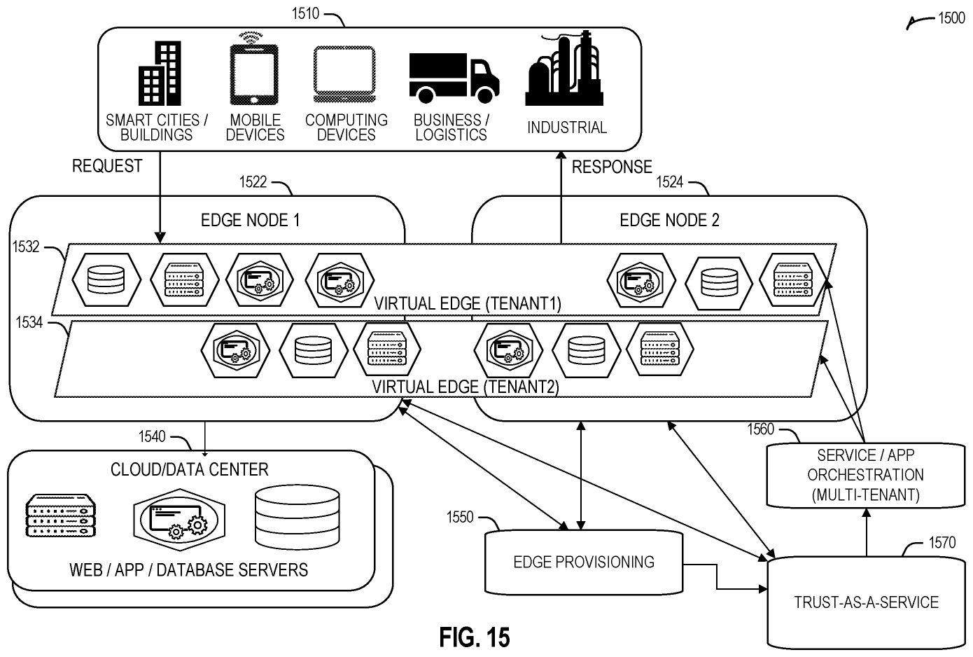

FIG. 15 illustrates deployment and orchestration for virtual edge configurations across an edge computing system operated among multiple edge nodes and multiple tenants. Specifically, FIG. 15 depicts coordination of a first edge node 1522 and a second edge node 1524 in an edge computing system 1500, to fulfill requests and responses for various client endpoints 1510 (e.g., smart cities/building systems, mobile devices, computing devices, business/logistics systems, industrial systems, etc.), which access various virtual edge instances. The virtual edge instances 1532, 1534 (or virtual edges) provide edge compute capabilities and processing in an edge cloud, with access to a cloud/data center 1540 for higher-latency requests for websites, applications, database servers, etc. Thus, the edge cloud enables coordination of processing among multiple edge nodes for multiple tenants or entities.

In the example of FIG. 15, these virtual edge instances include a first virtual edge instance 1532, offered to a first tenant (Tenant 1), which offers a first combination of edge storage, computing, and services; and a second virtual edge instance 1534, offering a second combination of edge storage, computing, and services, to a second tenant (Tenant 2). The virtual edge instances 1532, 1534 are distributed among the edge nodes 1522, 1524, and may include scenarios in which a request and response are fulfilled from the same or different edge nodes. The configuration of the individual edge nodes 1522, 1524 to operate in a distributed yet coordinated fashion occurs based on edge provisioning functions 1550. The functionality of the edge nodes 1522, 1524 to provide coordinated operation for applications and services, among multiple tenants, occurs based on orchestration functions 1560.

It should be understood that some of the devices in 1510 are multi-tenant devices where Tenant1 may function within a Tenant1 ‘slice’ while a Tenant2 may function within a Tenant2 ‘slice’ (and, in further examples, additional or sub-tenants may exist; and a respective tenant may be specifically entitled and transactionally tied to a specific set of features all the way to specific hardware features). A trusted multi-tenant device may further contain a tenant-specific cryptographic key such that the combination of a key and a slice may be considered a “root of trust” (RoT) or tenant-specific RoT. A ROT may further be computed dynamically composed using a compute security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The RoT also may be used for a trusted computing context to support respective tenant operations, etc. Use of this ROT and the compute security architecture may be enhanced by the attestation operations further discussed herein.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for a respective node. Accordingly, the respective RoTs spanning devices in 1510, 1522, and 1540 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other compute security functions related to the provisioning and lifecycle of the trusted ‘slice’ concept in FIG. 15. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or, respective computing systems and resources which are co-owned or co-managed by multiple owners).

For instance, a respective edge node 1522, 1524 may implement the use of containers, such as with the use of a container “pod” 1526, 1528 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edge instances 1532, 1534 are partitioned according to the needs of a respective container.

With the use of container pods, a pod controller oversees the partitioning and allocation of containers and resources. The pod controller receives instructions from an orchestrator (e.g., performing orchestration functions 1560) that instructs the controller on how to appropriately partition physical resources and for what duration, such as by receiving key performance indicator (KPI) targets based on SLA contracts. The pod controller determines which container uses which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a compute security role that prevents the assignment of resources until the right tenant authenticates or prevents provisioning of data or a workload to a container until an attestation result is satisfied.

Also, with the use of container pods, tenant boundaries can still exist but in the context of a respective pod of containers. If a respective tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestrator (that provides orchestration functions 1560) may provision an attestation verification policy to local pod controllers that perform attestation verification. If an attestation satisfies a policy for a first tenant pod controller but not a second tenant pod controller, then the second pod may be migrated to a different edge node that does satisfy it. Alternatively, the first pod may be allowed to execute and a different shared pod controller is installed and invoked before the second pod executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to an individual tenant (aside from the execution of virtualized network functions).

Within the edge cloud, a first edge node 1522 (e.g., operated by a first owner) and a second edge node 1524 (e.g., operated by a second owner) may operate or respond to a container orchestrator to coordinate the execution of various applications within the virtual edge instances offered for respective tenants. For instance, the edge nodes 1522, 1524 may be coordinated based on edge provisioning functions 1550, while the operation of the various applications is coordinated with orchestration functions 1560.

Various system arrangements may provide an architecture that treats VMs, Containers, and Functions equally in terms of application composition (and resulting applications are combinations of these three ingredients). A respective ingredient may involve the use of one or more accelerator (e.g., FPGA, ASIC, cryptographic execution) components as a local backend. In this manner, applications can be split across multiple edge owners, coordinated by an orchestrator.

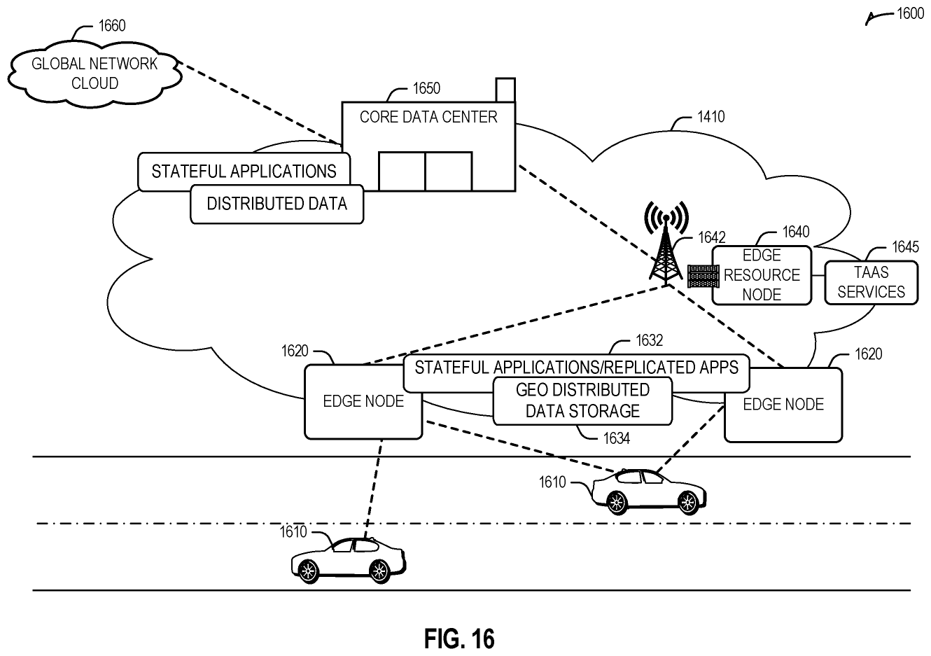

It should be appreciated that the edge computing systems and arrangements discussed herein may be applicable in various solutions, services, and/or use cases. As an example, FIG. 16 shows a simplified vehicle compute and communication use case involving mobile access to applications in an edge computing system 1600 that implements an edge cloud 1410 connected to Trust-as-a-Service (TaaS) instances 1645. In this use case, a client compute node 1610 may be embodied as in-vehicle compute systems (e.g., in-vehicle navigation and/or infotainment systems) located in corresponding vehicles that communicate with the edge gateway nodes 1620 during traversal of a roadway. For instance, edge gateway nodes 1620 may be located in roadside cabinets, which may be placed along the roadway, at intersections of the roadway, or other locations near the roadway. As a vehicle traverses along the roadway, the connection between its client compute node 1610 and a particular edge gateway node 1620 may propagate to maintain a consistent connection and context for the client compute node 1610. The respective nodes of the edge gateway nodes 1620 includes some processing and storage capabilities and, as such, some processing and/or storage of data for the client compute nodes 1610 may be performed on one or more of the edge gateway nodes 1620.

A respective node of the edge gateway nodes 1620 may communicate with one or more edge resource nodes 1640, which are illustratively embodied as compute servers, appliances or components located at or in a communication base station 1642 (e.g., a base station of a cellular network). As discussed above, a respective edge resource node 1640 includes some processing and storage capabilities, and, as such, some processing and/or storage of data for the client compute nodes 1610 may be performed on the edge resource node 1640. For example, the processing of data that is less urgent or important may be performed by the edge resource node 1640, while the processing of data that is of a higher urgency or importance may be performed by edge gateway devices or the client nodes themselves (depending on, for example, the capabilities of a respective component). Further, various wired or wireless communication links (e.g., fiber optic wired backhaul, 5G wireless links) may exist among the edge nodes 1620, edge resource node(s) 1640, core data center 1650, and network cloud 1660.

The edge resource node(s) 1640 also communicate with the core data center 1650, which may include compute servers, appliances, and/or other components located in a central location (e.g., a central office of a cellular communication network). The core data center 1650 may provide a gateway to the global network cloud 1660 (e.g., the Internet) for the edge cloud 1410 operations formed by the edge resource node(s) 1640 and the edge gateway nodes 1620. Additionally, in some examples, the core data center 1650 may include an amount of processing and storage capabilities and, as such, some processing and/or storage of data for the client compute devices may be performed on the core data center 1650 (e.g., processing of low urgency or importance, or high complexity). The edge gateway nodes 1620 or the edge resource nodes 1640 may offer the use of stateful applications 1632 and a geographically distributed data storage 1634 (e.g., database, data store, etc.).

In further examples, FIG. 16 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 1620, some others at the edge resource node 1640, and others in the core data center 1650 or the global network cloud 1660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity (a workload execution environment) such as a process, a Docker or Kubernetes container, a virtual machine, etc. Within the edge computing system, various data center, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

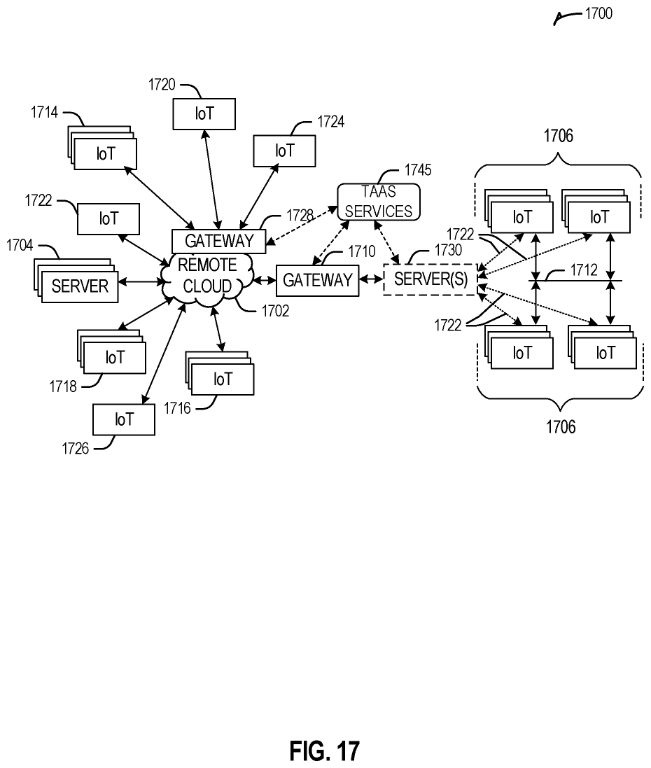

As a more detailed illustration of an Internet of Things (IOT) network, FIG. 17 illustrates a drawing of a cloud or edge computing network 1700, in communication with several IoT devices and a TaaS instance 1745. The IoT is a concept in which a large number of computing devices are interconnected with one other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 17, the network 1700 may represent portions of the Internet or may include portions of a local area network (LAN), or a wide area network (WAN), such as a proprietary network for a company. The IoT devices may include any number of different types of devices, grouped in various combinations. For example, a traffic control group 1706 may include IoT devices along streets in a city. These IoT devices may include stoplights, traffic flow monitors, cameras, weather sensors, and the like. The traffic control group 1706, or other subgroups, may be in communication within the network 1700 through wired or wireless links 1708, such as LPWA links, optical links, and the like. Further, a wired or wireless sub-network 1712 may allow the IoT devices to communicate with one another, such as through a local area network, a wireless local area network, and the like. The IoT devices may use another device, such as a gateway 1710 or 1728 to communicate with remote locations such as remote cloud 1702; the IoT devices may also use one or more servers 1730 to facilitate communication within the network 1700 or with the gateway 1710. For example, the one or more servers 1730 may operate as an intermediate network node to support a local edge cloud or fog implementation among a local area network. Further, the gateway 1728 that is depicted may operate in a cloud-to-gateway-to-many edge devices configuration, such as with the various IoT devices (stations 1714, machines 1720, vehicles 1724) being constrained or dynamic to an assignment and use of resources in the network 1700.

In an example embodiment, the network 1700 can further include or be communicatively coupled to a Trust-a-a-Service instance or deployment configured to perform trust attestation operations within the network 1700, such as that discussed above.

Other example groups of IoT devices may include remote weather stations 1714, local information terminals 1716, alarm systems 1718, automated teller machines 1720, alarm panels 1722, or moving vehicles, such as emergency vehicles 1724 or other vehicles 1726, among many others. These IoT devices may be in communication with other IoT devices, with servers 1704, with another IoT device or system, another edge computing or “fog” computing system, or a combination therein. The groups of IoT devices may be deployed in various residential, commercial, and industrial settings (including in both private or public environments).

As may be seen from FIG. 17, a large number of IoT devices may be communicating through the network 1700. This may allow different IoT devices to request or provide information to other devices autonomously. For example, a group of IoT devices (e.g., the traffic control group 1706) may request a current weather forecast from a group of remote weather stations 1714, which may provide the forecast without human intervention. Further, an emergency vehicle 1724 may be alerted by an automated teller machine 1720 that a burglary is in progress. As the emergency vehicle 1724 proceeds towards the automated teller machine 1720, it may access the traffic control group 1706 to request clearance to the location, for example, by lights turning red to block cross traffic at an intersection in sufficient time for the emergency vehicle 1724 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 1714 or the traffic control group 1706, may be equipped to communicate with other IoT devices as well as with the network 1700. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an Ipv6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, a LPWA link, or a link based on the IEEE 802.15.4 standard, such as Zigbee®. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QOS) based swarming and coordination/combinations of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of the assets and resources. Furthermore, the proper components of infrastructure and resource-based trust and service indices may be inserted to improve the data integrity, quality, assurance, and deliver a metric of data confidence.

### Example Computing Devices

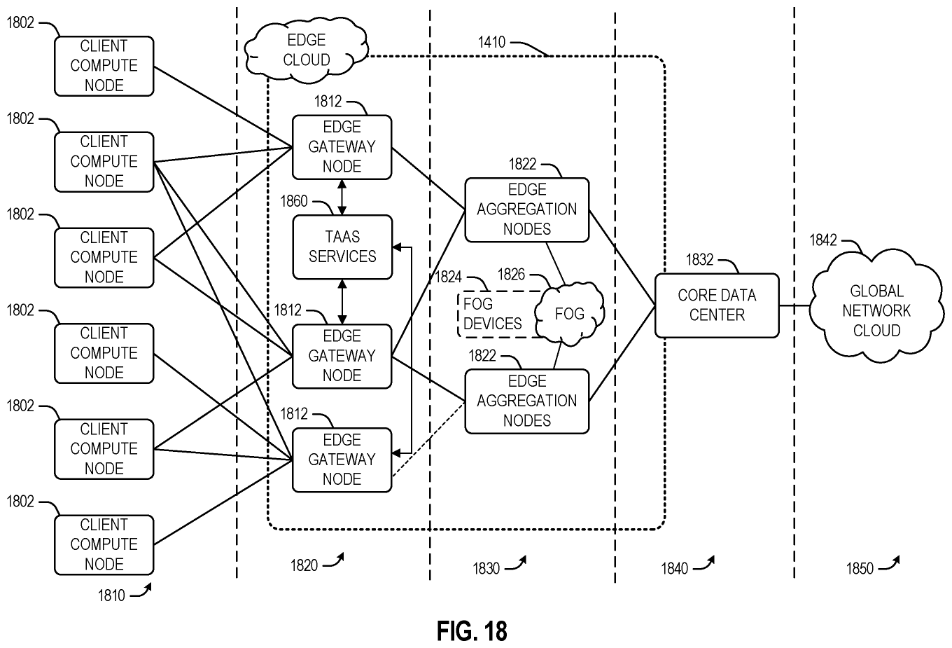

At a more generic level, an edge computing system may be described to encompass any number of deployments operating in the edge cloud 1410, which provide coordination from client and distributed computing devices. FIG. 18 provides a further abstracted overview of layers of distributed compute deployed among an edge computing environment for purposes of illustration.

FIG. 18 generically depicts an edge computing system for providing edge services and applications to multi-stakeholder entities, as distributed among one or more client compute nodes 1802, one or more edge gateway nodes 1812, one or more edge aggregation nodes 1822, one or more core data centers 1832, and a global network cloud 1842, as distributed across layers of the network. The implementation of the edge computing system may be provided at or on behalf of a telecommunication service provider (“telco” or “TSP”), internet-of-things service provider, a cloud service provider (CSP), enterprise entity, or any other number of entities. Various forms of wired or wireless connections may be configured to establish connectivity among the nodes 1802, 1812, 1822, and data center 1832, including interconnections among such nodes (e.g., connections among edge gateway nodes 1812, and connections among edge aggregation nodes 1822). Such connectivity and federation of these nodes may be assisted with the use of TaaS services 1860 and service instances, as discussed herein.

A respective node or device of the edge computing system is located at a particular layer corresponding to layers 1810, 1820, 1830, 1840, and 1850. For example, the client compute nodes 1802 are located at an endpoint layer 1810, while the edge gateway nodes 1812 are located at an edge devices layer 1820 (local level) of the edge computing system. Additionally, the edge aggregation nodes 1822 (and/or fog devices 1824, if arranged or operated with or among a fog networking configuration 1826) is located at a network access layer 1830 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 1832 is located at a core network layer 1840 (e.g., a regional or geographically-central level), while the global network cloud 1842 is located at a cloud data center layer 1850 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 1832 may be located within, at, or near the edge cloud 1410.

Although an illustrative number of client compute nodes 1802, edge gateway nodes 1812, edge aggregation nodes 1822, core data centers 1832, and global network clouds 1842 are shown in FIG. 18, it should be appreciated that the edge computing system may include more or fewer devices or systems at respective layers. Additionally, as shown in FIG. 18, the number of components of respective layers 1810, 1820, 1830, 1840, and 1850 generally increases at lower levels (e.g., when moving closer to endpoints). As such, one edge gateway node 1812 may service multiple client compute nodes 1802, and one edge aggregation node 1822 may service multiple edge gateway nodes 1812.

Consistent with the examples provided herein, a client compute node 1802 may be embodied as any type of end point component, device, appliance, or “thing” capable of communicating as a producer or consumer of data. Further, the label “node” or “device” as used in the edge computing system 1800 does not necessarily mean that such node or device operates in a client or minion/follower/agent role; rather, any of the nodes or devices in the edge computing system 1800 refer to individual entities, nodes, or subsystems which include discrete or connected hardware or software configurations to facilitate or use the edge cloud 1410.

As such, the edge cloud 1410 is formed from network components and functional features operated by and within the edge gateway nodes 1812 and the edge aggregation nodes 1822 of layers 1820, 1830, respectively. The edge cloud 1410 may be embodied as any type of network that provides edge computing and/or storage resources which are proximately located to radio access network (RAN) capable endpoint devices (e.g., mobile computing devices, IoT devices, smart devices, etc.), which are shown in FIG. 18 as the client compute nodes 1802. In other words, the edge cloud 1410 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1410 may form a portion of or otherwise provide an ingress point into or across a fog networking configuration 1826 (e.g., a network of fog devices 1824, not shown in detail), which may be embodied as a system-level horizontal and distributed architecture that distributes resources and services to perform a specific function. For instance, a coordinated and distributed network of fog devices 1824 may perform computing, storage, control, or networking aspects in the context of an IoT system arrangement. Other networked, aggregated, and distributed functions may exist in the edge cloud 1410 between the cloud data center layer 1850 and the client endpoints (e.g., client compute nodes 1802). Some of these are discussed in the following sections in the context of network functions or service virtualization, including the use of virtual edges and virtual services which are orchestrated for multiple stakeholders.

The edge gateway nodes 1812 and the edge aggregation nodes 1822 cooperate to provide various edge services and compute security features to the client compute nodes 1802. Furthermore, because an individual client compute node 1802 may be stationary or mobile, a respective edge gateway node 1812 may cooperate with other edge gateway devices to propagate presently provided edge services and compute security features as the corresponding client compute node 1802 moves about a region. To do so, respective nodes of the edge gateway nodes 1812 and/or edge aggregation nodes 1822 may support multiple tenancies and multiple stakeholder configurations, in which services from (or hosted for) multiple service providers and multiple consumers may be supported and coordinated across a single or multiple compute devices.

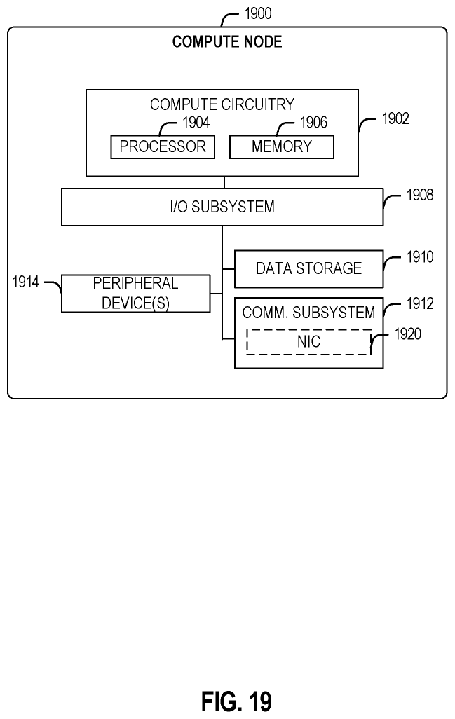

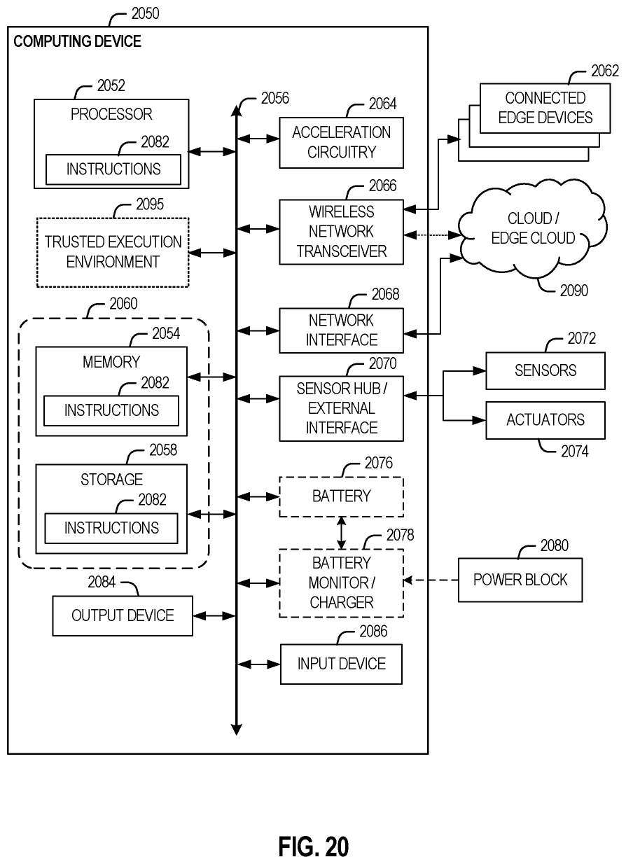

In further examples, any of the compute nodes or devices discussed with reference to the present edge computing systems and environment may be fulfilled based on the components depicted in FIGS. 19 and 20. An edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 19, an edge compute node 1900 includes a compute engine (also referred to herein as “compute circuitry”) 1902, an input/output (I/O) subsystem 1908, data storage device 1910, communication circuitry 1912, and, optionally, one or more peripheral devices 1914. In other examples, a respective compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1900 may be embodied as any type of engine, device, or collection of devices capable of performing various compute functions. In some examples, the compute node 1900 may be embodied as a single device such as an integrated circuit, an embedded system, a field-programmable gate array (FPGA), a system-on-a-chip (SOC), or other integrated system or device. In the illustrative example, the compute node 1900 includes or is embodied as a processor 1904 and a memory 1906. The processor 1904 may be embodied as any type of processor capable of performing the functions described herein (e.g., executing an application). For example, the processor 1904 may be embodied as a multi-core processor(s), a microcontroller, a processing unit, a specialized or special purpose processing unit, or other processor or processing/controlling circuit. In some examples, the processor 1904 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 1904 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), dedicated compute circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Units (DPUs), Edge Processing Units (EPUs), or other specialized compute units such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. Thus, any of the C2E techniques described herein and their accompanying attestation, trust, security, provisioning, testing, simulation, or orchestration functions may be coordinated by an xPU. However, it will be understood that an xPU, a SOC, a CPU, and other variations of the processor 1904 may work in coordination with each other to execute many types of operations and instructions within and on behalf of the compute node 1900.

The main memory 1906 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 1906 may be integrated into the processor 1904. The main memory 1906 may store various software and data used during operation such as one or more applications, data operated on by the application(s), libraries, and drivers.

The compute circuitry 1902 is communicatively coupled to other components of the compute node 1900 via the I/O subsystem 1908, which may be embodied as circuitry and/or components to facilitate input/output operations with the compute circuitry 1902 (e.g., with the processor 1904 and/or the main memory 1906) and other components of the compute circuitry 1902. For example, the I/O subsystem 1908 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1908 may form a portion of a system-on-a-chip (SoC) and be incorporated, along with one or more of the processor 1904, the main memory 1906, and other components of the compute circuitry 1902, into the compute circuitry 1902.

The one or more illustrative data storage devices 1910 may be embodied as any type of device configured for short-term or long-term storage of data such as, for example, memory devices and circuits, memory cards, hard disk drives, solid-state drives, or other data storage devices. A respective data storage device 1910 may include a system partition that stores data and firmware code for the data storage device 1910. A respective data storage device 1910 may also include one or more operating system partitions that store data files and executables for operating systems depending on, for example, the type of compute node 1900.

The communication circuitry 1912 may be embodied as any communication circuit, device, or collection thereof, capable of enabling communications over a network between the compute circuitry 1902 and another compute device (e.g., an edge gateway node 1812 of the edge computing system 1800). The communication circuitry 1912 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 1912 includes a network interface controller (NIC) 1920, which may also be referred to as a host fabric interface (HFI). The NIC 1920 may be embodied as one or more add-in-boards, daughter cards, network interface cards, controller chips, chipsets, or other devices that may be used by the compute node 1900 to connect with another compute device (e.g., an edge gateway node 1812). In some examples, the NIC 1920 may be embodied as part of a system-on-a-chip (SoC) that includes one or more processors or included on a multichip package that also contains one or more processors. In some examples, the NIC 1920 may include a local processor (not shown) and/or a local memory and storage (not shown) that are local to the NIC 1920. In such examples, the local processor of the NIC 1920 (which can include general-purpose accelerators or specific accelerators) may be capable of performing one or more of the functions of the compute circuitry 1902 described herein. Additionally, or alternatively, the local memory of the NIC 1920 may be integrated into one or more components of the client compute node at the board level, socket level, chip level, and/or other levels.

Additionally, in some examples, a respective compute node 1900 may include one or more peripheral devices 1914. Such peripheral devices 1914 may include any type of peripheral device found in a compute device or server such as audio input devices, a display, other input/output devices, interface devices, and/or other peripheral devices, depending on the particular type of the compute node 1900. In further examples, the compute node 1900 may be embodied by a respective edge compute node in an edge computing system (e.g., client compute node 1802, edge gateway node 1812, edge aggregation node 1822) or like forms of appliances, computers, subsystems, circuitry, or other components.

In a more detailed example, FIG. 20 illustrates a block diagram of an example of components that may be present in an edge computing device (or node) 2050 for implementing the techniques (e.g., operations, processes, methods, and methodologies) described herein. The edge computing node 2050 provides a closer view of the respective components of node 1900 when implemented as or as part of a computing device (e.g., as a mobile device, a base station, server, gateway, etc.). The edge computing node 2050 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 2050, or as components otherwise incorporated within a chassis of a larger system.

The edge computing node 2050 may include processing circuitry in the form of a processor 2052, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 2052 may be a part of a system on a chip (SoC) in which the processor 2052 and other components are formed into a single integrated circuit, or a single package, such as the Edison™ or Galileo™ SoC boards from Intel Corporation, Santa Clara, California. As an example, the processor 2052 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 2052 and accompanying circuitry may be provided in a single socket form factor, multiple socket form factor, or a variety of other formats, including in limited hardware configurations or configurations that include fewer than all elements shown in FIG. 20.

The processor 2052 may communicate with a system memory 2054 over an interconnect 2056 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 2058 may also couple to the processor 2052 via the interconnect 2056. In an example, the storage 2058 may be implemented via a solid-state disk drive (SSDD). Other devices that may be used for the storage 2058 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 2058 may be on-die memory or registers associated with the processor 2052. However, in some examples, the storage 2058 may be implemented using a micro hard disk drive (HDD) or solid-state drive (SSD). Further, any number of new technologies may be used for the storage 2058 in addition to, or instead of, the technologies described, such resistance change memories, phase change memories, holographic memories, or chemical memories, among others.

The components may communicate over the interconnect 2056. The interconnect 2056 may include any number of technologies, including industry-standard architecture (ISA), extended ISA (EISA), peripheral component interconnect (PCI), peripheral component interconnect extended (PCI-X), PCI express (PCIe), or any number of other technologies. The interconnect 2056 may be a proprietary bus, for example, used in an SoC based system. Other bus systems may be included, such as an I2C interface, an SPI interface, point to point interfaces, and a power bus, among others.

The interconnect 2056 may couple the processor 2052 to a transceiver 2066, for communications with the connected edge devices 2062. The transceiver 2066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2066 (or multiple transceivers) may communicate using multiple standards or radios for communications at a different range. For example, the edge computing node 2050 may communicate with close devices, e.g., within about 10 meters, using a local transceiver based on BLE, or another low power radio, to save power. More distant connected edge devices 2062, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 2066 (e.g., a radio transceiver) may be included to communicate with devices or services in the edge cloud 2090 via local or wide area network protocols. The wireless network transceiver 2066 may be an LPWA transceiver that follows the IEEE 802.15.4, or IEEE 802.15.4g standards, among others. The edge computing node 2050 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2066, as described herein. For example, the transceiver 2066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2068 may be included to provide a wired communication to nodes of the edge cloud 2090 or other devices, such as the connected edge devices 2062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 2068 may be included to enable connecting to a second network, for example, a first NIC 2068 providing communications to the cloud over Ethernet, and a second NIC 2068 providing communications to other devices over another type of network.

Given the variety of types of applicable communications from the device to another component or network, applicable communications circuitry used by the device may include or be embodied by any one or more of components (circuitry 2064, transceiver 2066, NIC 2068, or interface 2070). Accordingly, in various examples, applicable means for communicating (e.g., receiving, transmitting, etc.) may be embodied by such communications circuitry.

The edge computing node 2050 may include or be coupled to acceleration circuitry 2064, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 2056 may couple the processor 2052 to a sensor hub or external interface 2070 that is used to connect additional devices or subsystems. The devices may include sensors 2072, such as accelerometers, level sensors, flow sensors, optical light sensors, camera sensors, temperature sensors, a global navigation system (e.g., GPS) sensors, pressure sensors, barometric pressure sensors, and the like. The hub or interface 2070 further may be used to connect the edge computing node 2050 to actuators 2074, such as power switches, valve actuators, an audible sound generator, a visual warning device, and the like.

In some optional examples, various input/output (I/O) devices may be present within or connected to, the edge computing node 2050. For example, a display or other output device 2084 may be included to show information, such as sensor readings or actuator position. An input device 2086, such as a touch screen or keypad may be included to accept input. An output device 2084 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 2050. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2076 may power the edge computing node 2050, although, in examples in which the edge computing node 2050 is mounted in a fixed location, it may have a power supply coupled to an electrical grid, or the battery may be used as a backup or for temporary capabilities. The battery 2076 may be a lithium-ion battery, or a metal-air battery, such as a zinc-air battery, an aluminum-air battery, a lithium-air battery, and the like.

A battery monitor/charger 2078 may be included in the edge computing node 2050 to track the state of charge (SoCh) of the battery 2076. The battery monitor/charger 2078 may be used to monitor other parameters of the battery 2076 to provide failure predictions, such as the state of health (SoH) and the state of function (SoF) of the battery 2076. The battery monitor/charger 2078 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2078 may communicate the information on the battery 2076 to the processor 2052 over the interconnect 2056. The battery monitor/charger 2078 may also include an analog-to-digital (ADC) converter that enables the processor 2052 to directly monitor the voltage of the battery 2076 or the current flow from the battery 2076. The battery parameters may be used to determine actions that the edge computing node 2050 may perform, such as transmission frequency, mesh network operation, sensing frequency, and the like.

A power block 2080, or other power supply coupled to a grid, may be coupled with the battery monitor/charger 2078 to charge the battery 2076. In some examples, the power block 2080 may be replaced with a wireless power receiver to obtain the power wirelessly, for example, through a loop antenna in the edge computing node 2050. A wireless battery charging circuit, such as an LTC4020 chip from Linear Technologies of Milpitas, California, among others, may be included in the battery monitor/charger 2078. The specific charging circuits may be selected based on the size of the battery 2076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2058 may include instructions 2082 in the form of software, firmware, or hardware commands to implement the techniques described herein. Although such instructions 2082 are shown as code blocks included in the memory 2054 and the storage 2058, it may be understood that any of the code blocks may be replaced with hardwired circuits, for example, built into an application-specific integrated circuit (ASIC).

Also in a specific example, the instructions 2082 on the processor 2052 (separately, or in combination with the instructions 2082 of the machine readable medium 2060) may configure execution or operation of a trusted execution environment (TEE) 2095. In an example, the TEE 2095 operates as a protected area accessible to the processor 2052 for secure execution of instructions and secure access to data. Various implementations of the TEE 2095, and an accompanying secure area in the processor 2052 or the memory 2054 may be provided, for instance, through use of Intel® Software Guard Extensions (SGX), AMD® Secure Encrypted Virtualization (SEV), or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 2050 through the TEE 2095 and the processor 2052.

In an example, the instructions 2082 provided via memory 2054, the storage 2058, or the processor 2052 may be embodied as a non-transitory, machine-readable medium 2060 including code to direct the processor 2052 to perform electronic operations in the edge computing node 2050. The processor 2052 may access the non-transitory, machine-readable medium 2060 over the interconnect 2056. For instance, the non-transitory, machine-readable medium 2060 may be embodied by devices described for the storage 2058 or may include specific storage units such as optical disks, flash drives, or any number of other hardware devices. The non-transitory, machine-readable medium 2060 may include instructions to direct the processor 2052 to perform a specific sequence or flow of actions, for example, as described with respect to the flowchart(s) and block diagram(s) of operations and functionality depicted above. As used herein, the terms “machine-readable medium,” “computer-readable medium,” “machine-readable storage,” and “computer-readable storage” are interchangeable.

In an example embodiment, the edge computing node 2050 can be implemented using components/modules/blocks 2052-2086 which are configured as IP Blocks. An individual IP Block may contain a hardware RoT (e.g., device identifier composition engine, or DICE), where a DICE key may be used to identify and attest the IP Block firmware to a peer IP Block or remotely to one or more of components/modules/blocks 2062-2080. Thus, it will be understood that the node 2050 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 19 and 20 are intended to depict a high-level view of components of a device, subsystem, or arrangement of an edge computing node. However, it will be understood that some of the components shown may be omitted, additional components may be present, and a different arrangement of the components shown may occur in other implementations.

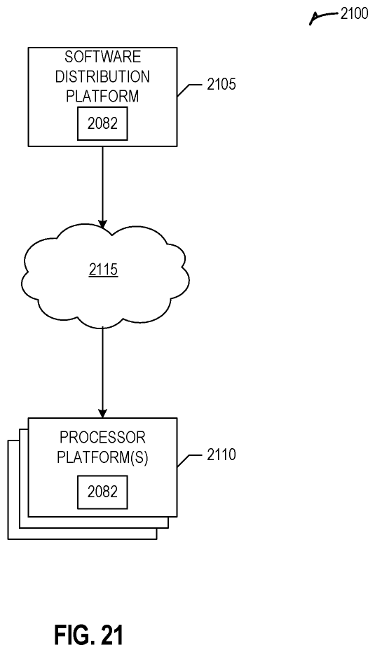

FIG. 21 illustrates an example software distribution platform 2105 to distribute software, such as the example computer readable instructions 2082 of FIG. 20, to one or more devices, such as example processor platform(s) 21 and/or other example connected edge devices or systems discussed herein. The example software distribution platform 2105 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 2105). Example connected edge devices may operate in commercial and/or home automation environments. In some examples, a third party is a developer, a seller, and/or a licensor of software such as the example computer readable instructions 2082 of FIG. 20. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) that are geographically and/or logically separated (e.g., physically separated IoT devices chartered with the responsibility of water distribution control (e.g., pumps), electricity distribution control (e.g., relays), etc.).

In the illustrated example of FIG. 21, the software distribution platform 2105 includes one or more servers and one or more storage devices that store the computer readable instructions 2082. The one or more servers of the example software distribution platform 2105 are in communication with a network 2115, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2082 from the software distribution platform 2105. For example, the software, which may correspond to example computer readable instructions, may be downloaded to the example processor platform(s), which is/are to execute the computer readable instructions 2082. In some examples, one or more servers of the software distribution platform 2105 are communicatively connected to one or more security domains and/or security devices through which requests and transmissions of the example computer readable instructions 2082 must pass. In some examples, one or more servers of the software distribution platform 2105 periodically offer, transmit, and/or force updates to the software (e.g., the example computer readable instructions 2082 of FIG. 20) to ensure improvements, patches, updates, etc. are distributed and applied to the software at the end user devices.

In the illustrated example of FIG. 21, the computer readable instructions 2082 are stored on storage devices of the software distribution platform 2105 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 2082 stored in the software distribution platform 2105 are in a first format when transmitted to the example processor platform(s) 2110. In some examples, the first format is an executable binary in which particular types of the processor platform(s) 2110 can execute. However, in some examples, the first format is uncompiled code that requires one or more preparation tasks to transform the first format to a second format to enable execution on the example processor platform(s) 2110. For instance, the receiving processor platform(s) 2100 may need to compile the computer readable instructions 2082 in the first format to generate executable code in a second format that is capable of being executed on the processor platform(s) 2010. In still other examples, the first format is interpreted code that, upon reaching the processor platform(s) 2110, is interpreted by an interpreter to facilitate execution of instructions.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

1. A computing node configured to coordinate attestation for a distributed workload, comprising:
processing circuitry; and
a memory device including instructions embodied thereon, wherein the instructions, which when executed by the processing circuitry, configure the processing circuitry to cause operations that:
generate, with an attestation service, first attestation information to provide attestation of a resource at the computing node;
generate, with the attestation service, second attestation information to provide attestation of a microservice at the computing node, the microservice to use the resource at the computing node;
generate, with the attestation service, third attestation information to provide attestation of a distributed workload, the distributed workload to execute the microservice at the computing node; and
output an attestation result for the distributed workload, based on the first attestation information, the second attestation information, and the third attestation information.

2. The computing node of claim 1, wherein the attestation result is a composite token, the composite token including the first attestation information and an associated first signature, the second attestation information and an associated second signature, and the third attestation information and an associated third signature.

3. The computing node of claim 1, wherein the first attestation information is provided in a first token, wherein the second attestation information is provided in a second token, and wherein the third attestation information is provided in a third token.

4. The computing node of claim 3, wherein the first token is generated in response to a first attestation request from the resource, wherein the second token is generated in response to a second attestation request from the microservice, and wherein the third token is generated in response to a third attestation request from the distributed workload.

5. The computing node of claim 1, wherein the computing node is one of a plurality of nodes in a computing cluster, and wherein the attestation result is provided to another computing node of the plurality of nodes in connection with attestation for the distributed workload.

6. The computing node of claim 5, wherein the plurality of nodes in the computing cluster includes respective attestation services to provide an attestation service mesh, wherein the respective attestation services are coordinated in the attestation service mesh to distribute separate functions for the attestation of the distributed workload.

7. The computing node of claim 5, wherein execution of the distributed workload is coordinated by a workload mesh formed by the computing cluster, and wherein execution of the microservice is coordinated by a microservice mesh formed by the computing cluster.

8. The computing node of claim 1, wherein the attestation service includes a plurality of functions that implement attestation verification processing, the plurality of functions provided from among: certificate path construction, reference integrity manifest (RIM) management, signature verification, trust anchor management, evidence management, tag lifecycle management, attestation results creation, attestation results integrity protection, or attestation results issuance.

9. The computing node of claim 1, wherein the attestation service and the distributed workload are separated as different tenants within the computing node, based on hardware and software isolation.

10. The computing node of claim 1, wherein the resource at the computing node includes at least one of: an infrastructure computing unit, a central processing unit (CPU), a graphics processing unit (GPU), or an accelerator.

11. At least one non-transitory machine-readable storage medium comprising instructions stored thereupon, which when executed by processing circuitry of a computing node, cause the processing circuitry to:
generate, with an attestation service, first attestation information to provide attestation of a resource at the computing node;
generate, with the attestation service, second attestation information to provide attestation of a microservice at the computing node, the microservice to use the resource at the computing node;
generate, with the attestation service, third attestation information to provide attestation of a distributed workload, the distributed workload to execute the microservice at the computing node; and
output an attestation result for the distributed workload, based on the first attestation information, the second attestation information, and the third attestation information.

12. The machine-readable storage medium of claim 11, wherein the attestation result is a composite token, the composite token including the first attestation information and an associated first signature, the second attestation information and an associated second signature, and the third attestation information and an associated third signature.

13. The machine-readable storage medium of claim 11, wherein the first attestation information is provided in a first token, wherein the second attestation information is provided in a second token, and wherein the third attestation information is provided in a third token.

14. The machine-readable storage medium of claim 13, wherein the first token is generated in response to a first attestation request from the resource, wherein the second token is generated in response to a second attestation request from the microservice, and wherein the third token is generated in response to a third attestation request from the distributed workload.

15. The machine-readable storage medium of claim 11, wherein the computing node is one of a plurality of nodes in a computing cluster, and wherein the attestation result is provided to another computing node of the plurality of nodes in connection with attestation for the distributed workload.

16. The machine-readable storage medium of claim 15, wherein the plurality of nodes in the computing cluster includes respective attestation services to provide an attestation service mesh, wherein the respective attestation services are coordinated in the attestation service mesh to distribute separate functions for the attestation of the distributed workload.

17. The machine-readable storage medium of claim 15, wherein execution of the distributed workload is coordinated by a workload mesh formed by the computing cluster, and wherein execution of the microservice is coordinated by a microservice mesh formed by the computing cluster.

18. The machine-readable storage medium of claim 11, wherein the attestation service includes a plurality of functions that implement attestation verification processing, the plurality of functions provided from among: certificate path construction, reference integrity manifest (RIM) management, signature verification, trust anchor management, evidence management, tag lifecycle management, attestation results creation, attestation results integrity protection, or attestation results issuance.

19. The machine-readable storage medium of claim 11, wherein the attestation service and the distributed workload are separated as different tenants within the computing node, based on hardware and software isolation.

20. The machine-readable storage medium of claim 11, wherein the resource at the computing node includes at least one of: an infrastructure computing unit, a central processing unit (CPU), a graphics processing unit (GPU), or an accelerator.
